(19) United States
(12) Patent Application Publication
(10) Pub. No.: US 2026/0194761 A1
(43) Pub. Date: Jul. 9, 2026

(54) SYSTEMS AND METHODS FOR INTEGRATING VIRTUAL DISPLAY SYSTEMS USING FIELD EVOLVING CAVITIES INTEGRATED IN A VEHICLE

(71) Applicant: BRELYON INC., San Mateo, CA (US)

(72) Inventors: Barmak Heshmat DEHKORDI, San Mateo, CA (US); Christopher BARSI, Lee, NH (US)

(73) Assignee: BRELYON INC., San Mateo, CA (US)

(21) Appl. No.: 18/715,472

(22) PCT Filed: Dec. 13, 2023
(86) PCT No.: PCT/US2023/083862

§ 371 Date: May 31, 2024

Related U.S. Application Data
(63) Continuation of application No. 18/066,844, filed on Dec. 15, 2022, now Pat. No. 12,393,040.

(51) Int. Cl. G02B 27/02; G02B 27/01; G02B 27/14

(52) U.S. Cl. CPC G02B 27/026; G02B 27/0101; G02B 27/141; G02B 2027/0127

(57) ABSTRACT

A display system and method for generating virtual images or light field images includes, in some embodiments, a display and a field-evolving cavity. The field-evolving cavity modules the optical depth of the virtual image. In some embodiments, the display system is integrated into a part of a vehicle. The virtual image may be reflected by a portion of the vehicle and produce augmented reality (AR) environments for a passenger.

This application claims priority to International Application No. PCT/US23/83862, with an international filing date of Dec. 13, 2023, and titled “Systems and Methods for Integrating Virtual Display Systems Using Field Evolving Cavities Integrated in a Vehicle,” which itself claims priority to application no. Ser. No. 18/066,844, filed on Dec. 15, 2022, and titled “System and Method for Generating Compact Light-Field Displays through Varying Optical Depths,” which are herein incorporated by reference in their entirety.

### FIELD OF THE INVENTION

The present invention relates generally to light-field displays. More specifically, the present invention is a system for creating compact light-field displays through varying optical depths.

### BACKGROUND OF THE INVENTION

In present society, there has been an increasing traction towards more immersive light-field and/or autostereoscopic three-dimensional (3D) displays due to advancements in electronics and micro fabrications. Unlike stereoscopic 3D, light-field displays manipulate the wavefront to create depth perception at the monocular level. This can eliminate the accommodation-vergence mismatch and reduce stress on the user's eyes. There have been breakthroughs for realizing more realistic light-field experiences, which can be described in four major methods for creating such experiences, each method each having its own weaknesses and advantages: super multi-view, computational, multi-focal, and holographic. The super multi-view method provides a light-field at a very compact form but is limited to a very small viewing zone and low resolution. The computational method increases the resolution but produces haze and temporal flickering artifacts. The holographic method can struggle with color nonuniformity and fringing or specular artifacts. The multi-focal method can produce clean, but not scalable, images. Also, devices employing a multi-focal method can be bulky. However, universal to all current methods of light field displays are these following issues: large bandwidth requirements; a reliance on expensive and/or advanced components that are not easily mass produced such as tunable lenses; poor color uniformity, small field of view or viewing zone, low brightness, haze and diffraction artifacts, limited depth range; and the occasional necessity to wear specialized glasses. These challenges have significantly limited the use or production of light-field displays in commercial and/or industrial settings. Therefore, what is needed is a thorough class of optical methods that in some embodiments uses a set of reflectors positioned in a cavity to multiplex different liquid crystal displays (LCDs) or different portions of a single LCD onto different optical focal planes. This can allow a light-field within the cavity to adapt into or to certain optical depth(s) before it exits the cavity's exit pupil, while resolving the previously discussed issues associated with other methods of light-field display.

An objective of the present invention is to provide users with a device that can be a compact system of creating light-field displays at or through varying optical depths. The present invention intends to provide users with a device that address the previously discussed issues associated with current methods of light field displays. The present invention intends to provide users with a device that is less expensive and easier to produce at or for commercial and/or industrial levels. The present invention intends to provide users with a device that reduces artifacts without reducing the clarity of the light-field display. The present invention intends to provide users with a device that allows users to produce content for light-field displays more easily than conventional stereoscopic displays. The present invention intends to provide users with a device that does not require additional accessories or specialized components to be utilized by the user in order to view the content of the light-field display, such as specialized glasses or rending engines, respectively. The present invention intends to provide users with a device that can reduce an optical path difference to each focal plane of the light-field display and minimize the light loss from polarization. The present invention intends to provide users with a device that can vary the display focal plane without any mechanical motion.

### SUMMARY OF THE INVENTION

The present invention is a system for creating compact light-field displays through varying optical depths. The present invention primarily contains a housing. The housing contains a plurality of panels in a variety of arrangements in which the present invention can produce light-field displays of varying degrees or scope. The present invention also contains a relay panel. The present invention contains a cover case atop the housing.

Realizing accurate light-field displays usually requires advanced optical structures that use high-cost light sources and spatial modulators such as laser scanners, tunable lenses; liquid crystal on silicon (LCOS) reflectors or digital micro-mirror devices (DMDs). Accordingly, these existing methods do not provide true optical depth which means that there is inaccuracy in the wavefront in the form of diffraction color inaccuracy, speckle, or haze. A class of displays systems and methods revolves around the concept of field-evolving (FE) cavities. These cavities prepare the light in such a way that it provides true optical depth with no distortion to the wavefront, and, therefore, the images provided by such systems are as accurate as a normal display panel. This method uses conventional LCD or organic light-emitting diode (OLED) panel displays in a fashion that provides multiple optical focal planes simultaneously or sequentially in opaque or augmented (transparent) modality. The system can also be conveniently packaged in a small form factor well suited to desktop uses. Since the cavity feeds regular two-dimensional (2D) images and combines them optically into a 3D light-field, there is no need for complex rendering engines. The methods are also scalable to large-scale displays for commercial uses.

### BRIEF DESCRIPTION OF THE DRAWINGS

The patent of application file contains at least one drawing executed in color. Copies of this patent or patent application publication with color drawing(s) will be provided by the office upon request and payment of the necessary fee.

The following description illustrates aspects of embodiments of the disclosed apparatuses, methods, and systems in more detail, by way of examples, which are intended to be non-limiting and illustrative with reference to the accompanying drawings, in which:

FIG. 1 illustrates a light-field display based on a three-layer field-evolving cavity, wherein a non-limiting example of the 3D model of a three-layer light-field display prototype is shown, wherein a front view is shown on the left, a back top view is shown in the middle, and a front side view is shown on the right.

FIG. 2 illustrates a generalized block diagram of the cavity-based light-field systems in this disclosure, wherein a block diagram of a FE cavity-based light-field display system is shown, and wherein the cavity generates light of multiple focal planes and feeds it to a relay mechanism which then projects it to outside world.

FIGS. 3A, 3B, and 3C illustrate Class I FE cavities examples with first-order exit pupil, in which displays are arranged in one dimension or one axis (either vertical or horizontal), and the light for each layer bounces from each reflector only once, meaning there are no roundtrips or loops that light travels before exiting the cavity, wherein nonlimiting examples of different designs under Class I FE cavities category, ranging from simple to more complex with a greater number of layers, are shown.

FIG. 4 illustrates instances of Class II FE cavities with first-order exit pupil, such that Class II displays can be arranged in two dimensions (both horizontal and vertical) to make up the cavity, wherein the term “first order” refers to the fact the light bounces from each mirror or reflector no more than once, and wherein more complex Class II FE cavity examples showing how multiple displays can be incorporated along two axes to avoid losing spatial resolution incurred when splitting a display in Class I cavities are shown, and wherein the orange arrow is the light bundle exiting the pupil of the cavity.

FIG. 5 illustrates instances of Class I and Class II FE cavities with first-order and second-order exit pupils designed to reduce the optical path difference to each focal plane and minimize light loss are shown; “second order” means that the light may bounce from a reflector up to two times, wherein examples of FE cavities with higher order exit pupil that are designed to reduce the optical path difference to each focal plane and minimize light loss by using polarization are shown.

FIG. 6 illustrates examples of FE cavities with actively translated (mechanically translated) components used to adjust or sweep the focal plane through a range of depths, wherein instances of FE cavities with mechanically translated components to actively adjust or sweep the focal plane through a range of depths are shown.

FIG. 7 illustrates instances of FE cavities that involve switchable mirror elements and switchable diffusers to change the focal depth of the exiting light, and wherein examples of display cavities using switchable mirrors (from Profiles 22, 23 in FIG. 6) and switchable diffusers (from Profile 24 in FIG. 6) to vary the display focal plane without gross mechanical motion are shown.

FIG. 8 illustrates examples of using switchable liquid crystal layers to switch the path that light takes inside different sections of the FE cavity, wherein instances of FE cavities using switchable liquid crystal layers to vary the display focal plane without any mechanical motion are shown.

FIG. 9 illustrates examples of wedge type (or angled) FE cavities used to produce multiple focal planes, wherein in such cavities the display plane normal vectors may make angles other than multiples of 90 degrees with regards to each other, and wherein examples of compact Class I and II wedge cavities used to produce multiple focal planes in smaller form factors are shown.

FIG. 10 illustrates instances in which one or all of the depth is shifted using higher refractive index slabs or prisms, wherein it also shows how prismatic film can improve the brightness of a focal plane, and wherein examples of passively tuning or enhancing the depth and brightness of focal planes using material with different refractive index within the cavity volume or prismatic films are shown.

FIG. 11 illustrates instances of a relay system that can be used to relay light from the cavity to the outside world, wherein the display might be used as a far standing display or used very close to the head as on a desktop, and wherein the relays might be fully transparent or opaque, curved or flat, one piece or comprising multiple switching sections, and wherein diagrams show how display cavities'outputs can be relayed to the viewer as part of an entertainment system or a magnified monitor, and wherein the left column shows entertainment system modalities, and wherein the right side shows magnified near-head display modalities.

FIG. 12 illustrates instances of compressed FE cavities based on switchable mirrors, wherein the thickness of the cavity (L) can be reduced by having the reflectors turned on and off sequentially, and wherein diagrams show how the compressed architecture with switchable mirrors in Class I FE cavities can compress the size of the system.

FIG. 13 illustrates the exploded view of a prototype model of a three-layer light-field display, wherein a 3D model of a prototype system is shown, and wherein the left panel is the back of the exploded model, while the right panel is the front of the display, and wherein the light-field exits the green reflector on top.

FIG. 14A illustrates an embodiment where an aperture optics is positioned at the cavity exit pupil of the field-evolving cavity.

FIG. 14B illustrates an embodiment where an aperture optics is positioned at the enclosure exit pupil of the system enclosure.

FIG. 15 illustrates an embodiment of the field-evolving cavity being configured as a light pipe in which elements of the present invention are segmented to produce multiple depths or images.

FIG. 16 illustrates an embodiment of the present invention where the field-evolving cavity is in optical communication with a mirror, the embodiment producing a virtual image at the same depth or a closer depth as the viewer's reflection.

FIG. 17 illustrates an embodiment of the present invention where the field-evolving cavity is integrated into the roof of a vehicle.

FIGS. 18A through 18F show various embodiments of the display system illustrated in FIG. 17, the embodiments using polarization-dependent reflectors or semi-reflectors.

FIGS. 19A through 19F show exemplary ways that a display system may be integrated in a car, including mechanically articulated or motorized couplings.

FIGS. 20A through 20E depict example applications of the display systems and field evolving cavities disclosed.

### DETAILED DESCRIPTION OF THE INVENTION

All illustrations of the drawings are for the purpose of describing selected versions of the present invention and are not intended to limit the scope of the present invention.

In conventional binocular or stereographic vision, the display system provides two offset images separately to the left and right eye of the viewer. These two-dimensional images along with accommodation of the eye lenses are then combined in the brain of the viewer to give the perception of 3D depth in front of the viewer. If the true optical depth (curvature of the wavefront) does not match the parallax provided by the stereoscopic images, then the viewer experiences a bit of uncomfortable inaccuracy, since his/her eye lenses are telling the brain that the image is at a certain distance and that the parallax is telling the brain otherwise. This is known as accommodation-vergence mismatch. Light-field display systems change the wavefront in such a way as to provide both parallax and accommodation cues. Conventional methods of providing light-field displays has been limited by cost, accuracy of the image, bandwidth, the need for wearing headsets or glasses, bulkiness, and manufacturability.

To overcome this tradeoff between perceived content realism and manufacturability, the present invention uses a field-evolving cavity built around conventional LCD or OLED panel displays to produce digital content at one or more display focal depths which are then relayed to the outside world. This approach does not require tunable lenses, extensive computational rendering engines; it also does not necessarily rely on freeform optics, can be cost-efficiently manufactured, and provides the light-field experience for any number of users within the large viewing zone.

### General Purpose

The present invention provides a multi-layer light-field experience in a mass producible way with image accuracy comparable to high-quality displays. The purpose of the present invention is the realization of a compact and practical transparent or opaque light-field display, which does not suffer from accommodation-vergence conflict and does provide true optical depth. Such a display has wide-ranging utility in a variety of contexts, further elaborated upon hereinafter. The light-field can be used as an entertainment display, for commercial applications, or industrial use cases such as in navigation or biomedical use cases. In near-head use cases, the present invention provides virtual depth or optical space which seems like a virtual window and can provide a sense of scale despite having a small pupil. For example, the present invention can magnify a 13-inch exit pupil sitting 10 inches from the head to appear as a 60-inch monitor sitting 3 meters away from the user.

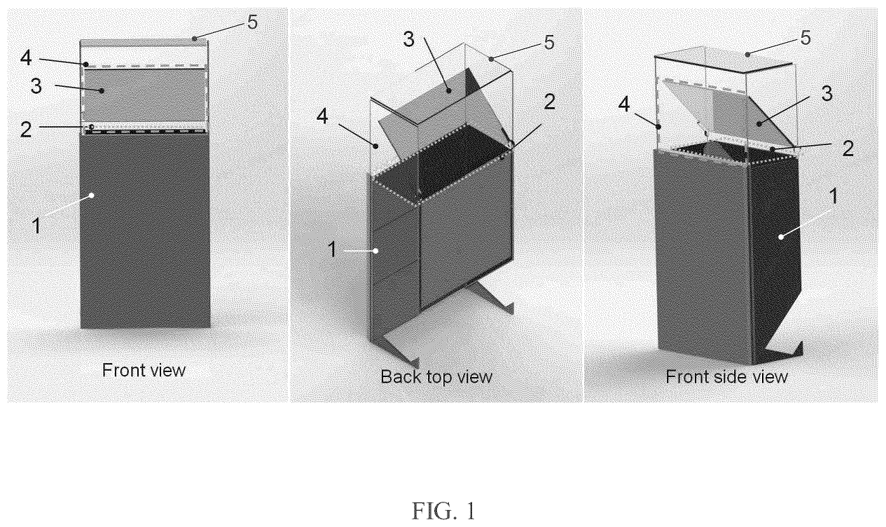

In the preferred embodiment, the present invention comprises a system enclosure 5, a field-evolving cavity 1, and a relay mechanism 3, which are shown in FIG. 1 through FIG. 13. The system enclosure 5 is used to house the other components of the present invention. Thus, the field-evolving cavity 1 and the relay mechanism 3 are mounted within the system enclosure 5. The field-evolving cavity 1 is a compact body that is responsible for modifying the light-field displays.

Moreover, the field-evolving cavity 1 comprises a cavity exit pupil 2, at least one display panel 6, and at least one optical-tuning mechanism 7. The display panel 6 generates the initial light-field display, which is modified by the optical-tuning mechanism 7, and the modified light-field display is then outputted by the cavity exit pupil 2. In addition, the display panel 6 and the optical-tuning mechanism 7 are configured into a specific optical arrangement, which allows for at least one light-field display 6 to be generated with at least one focal plane along at least one optical path. The optical path specifically traverses from the display panel 6 to the cavity exit pupil 2. The relay mechanism 3 is used to transfer the modified light-field display from the cavity exit pupil 2 to an enclosure exit pupil 4 of the system enclosure 5, and, thus, the cavity exit pupil 2 is in optical communication with the enclosure exit pupil through the relay mechanism 3.

FIG. 1 illustrates the field-evolving cavity 1 for a prototype model of the present invention. The cavity exit pupil 2 is also shown by a dotted line rectangular frame in FIG. 1. The relay mechanism 3 in this case is a simple mirror or switchable mirror and relays the cavity exit pupil 2 to the enclosure exit pupil 4. The enclosure exit pupil 4 also allows the light that exits this pupil to reach the user or users directly with no further manipulation. This enclosure exit pupil 4 is shown with a dashed line rectangular frame in FIG. 1.

### Technical Description

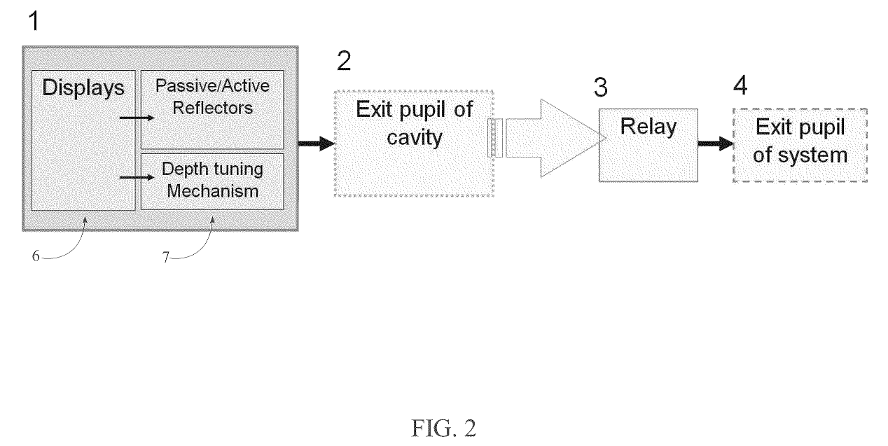

Aspects of the disclosed apparatuses, methods, and systems describe various methods, systems, components, and techniques that enable the display of digital content at two or more focal planes and contribute to a significant reduction of the size and cost of the light-field display systems. The disclosed apparatuses, methods, and systems work by generating digital content at multiple depths within a field-evolving cavity 1 and relaying this content to the user's eyes, as illustrated in FIG. 2.

First, digital content is generated within a field-evolving cavity 1, at one or more depths. This may be done in a variety of ways, the details of which are described in the section titled, “Design of the field-evolving cavity.” Then, a relay mechanism 3 is used to enable a user to view the digital content in different modalities, the details of which are described in the section titled, “Relay mechanisms and application modalities.”

Additionally, the technology described herein may be used not only for larger-scale displays such as desktop monitors, television sets, and heads-up displays but also in a new modality of near-head displays. The details of this application extension are described in the section titled, “Relay mechanisms and application modalities.” The thickness of the field-evolving cavity 1 may be reduced with the use of sequential relaying inside and outside of the field-evolving cavity 1, the details of which is explained in the section titled, “Compressed designs.” Details of a nonlimiting example of a practical prototype are given in the section entitled, “Prototype model.”

This disclosure has four major aspects or focuses: (1) the design of the field-evolving cavity 1 necessary to generate one or multiple focal planes from one or more display panels; (2) the methods of generating different tunable focal planes (i.e., light-fields with tunable planes) by varying or elaborating the cavity arrangement or using switchable mirrors or LCD layers; (3) elaboration on the means of relaying light from the cavity exit pupil 2 to the enclosure exit pupil 4; and (4) elaboration of compressed designs and near-head use cases.

### Design of the Field-evolving Cavity

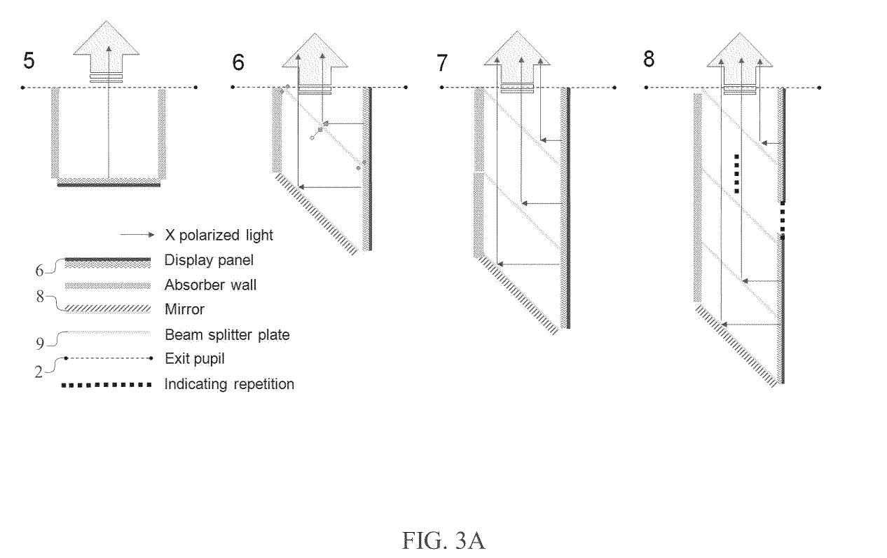

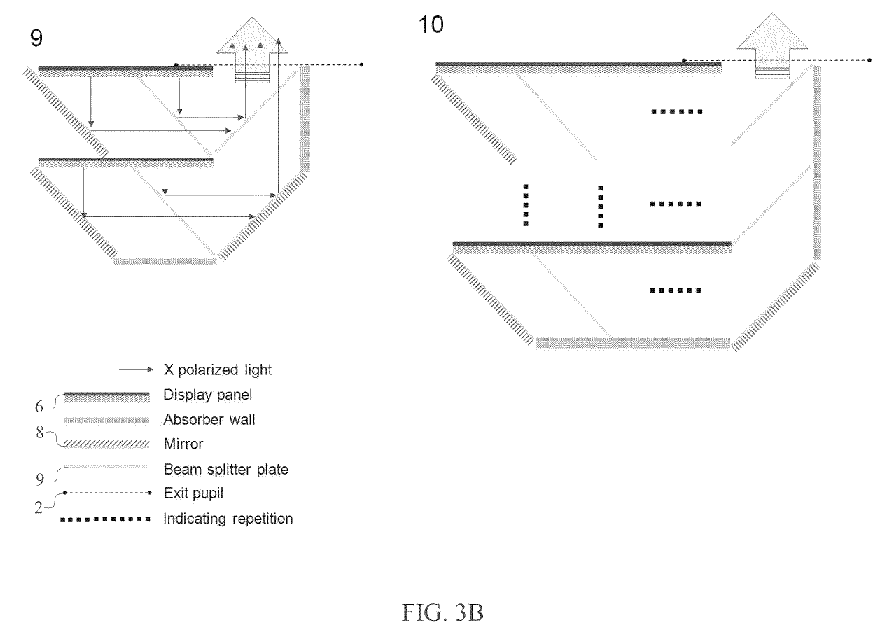

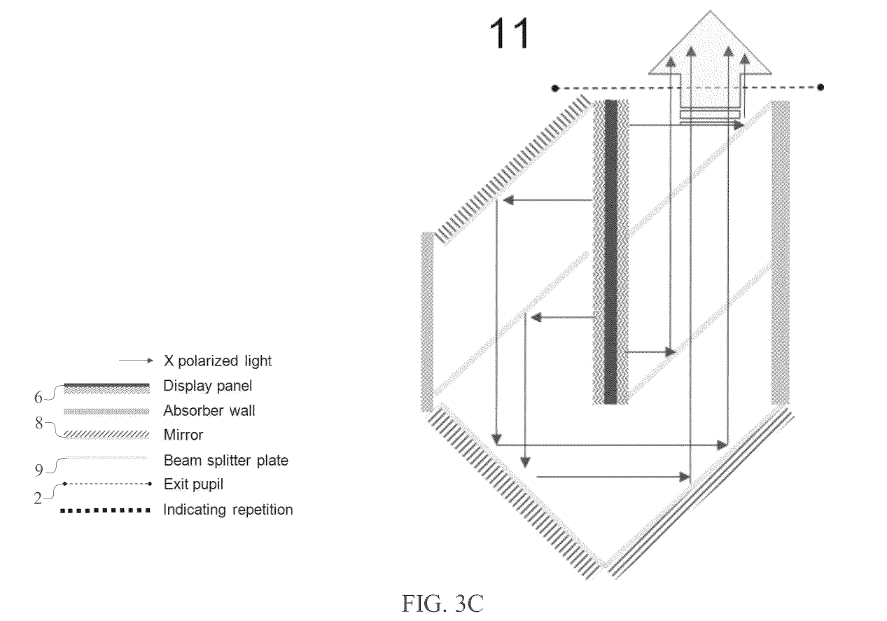

In order to provide true optical depth for different layers of a light-field, there needs to be an optical mechanism that prepares or manipulates the curvatures of the wavefront of the light which is true to that depth or correct for that depth. The various embodiments of the field-evolving cavity 1, illustrated in FIGS. 3 through 13, are cavities or void spaces comprising at least one display panel 6 (based on Liquid Crystal Displays (LCD), Thin-film Transistor (TFT), Light Emitting Diode (LED), Organic Light Emitting Diode arrays (OLED), Active Matrix Organic Light Emitting Diode (AMOLED), projection on flat screen or any other display technology) and/or at least one mirror 8 and/or at least one half mirror 9 and/or a plurality of switchable mirrors 13 or at least one liquid crystal cell layer 16 arranged and assembled in such a way as to exit bundles of light with divergence apexes at different depths from the cavity exit pupil 2. These apexes can be from different displays at different depths inside the field-evolving cavity 1 or from a single display panel 6 along the entirety of the field-evolving cavity 1. The cavity exit pupil 2 delivers light into a relay mechanism 3, resulting in a different or the same reference apex (depending on the type of relay) of divergence for different focal planes being presented to the user. The relaying mechanism 3 can be a simple flat surface, or a free-form curved surface as further discussed herein, or it can be a geometrical or diffractive waveguide, or any other suitable relay means. The relay mechanism 3 can be semi-transparent, opaque, or tunable in transparency (e.g. a switchable mirror).

Since theoretically, there is an infinite number of these types of field-evolving cavities, determining a class of the field-evolving cavity 1 is based on the dimensionality of display arrangement. If all of the display panels 6 are along a single axis (e.g. the y axis), then the field-evolving cavity 1 is defined as Class I. More specifically, the display panel 6 is positioned along the single axis, and the single axis is positioned either perpendicular or parallel to the cavity exit pupil 2. Alternatively, if all of the display panels 6 are arranged in both x and y dimensions, then the field-evolving cavity 1 is Class II. More specifically, a plurality of display panels 6 is positioned along a pair of axes, and the pair of axes is positioned perpendicular to each other, while each of the pair of axes being positioned either perpendicular or parallel to the cavity exit pupil 2. Furthermore, the order of the cavity exit pupil 2 is the maximum number of times that the light bundle from any pixel of the display panel 6 is reflected before it exits the cavity exit pupil 2. Any field-evolving cavity 1 that has at least one display panel 6 arranged at an angle that is not a multiple of 90 degrees in x and y is still considered as a Class II cavity but are referred to as Class II wedge cavities or angled cavities. More specifically, the display panel 6 is positioned along an alignment axis, and the alignment axis is positioned at an angle to the cavity exit pupil 2.

The following descriptions and drawings in FIGS. 3 through 13 provide non-limiting examples of Class I field-evolving cavities, which can be used to generate digital content at multiple focal depths using a single display panel 6 or multiple display panels 6 in parallel arrangements. In all of these configurations, the display panel 6 can use a variety of display technologies such as OLED, LCD, LED, AMOLED, or any display technologies or projection screen that provides a 2D image. In non-limiting examples of these conceptions, the display panel 6 can be replaced with an LCOS (Liquid crystal on silicon) spatial light modulator illuminated by a sequential RGB light, or DMD (Digital Mirror Device) spatial light modulator illuminated by a display. Therefore, in this disclosure, a “display panel” refers to any architecture that provides an array of light that can be focused or collimated to create an image.

In all non-limiting examples and configurations given in FIGS. 3 through 9, the reflectors can be polarization-dependent reflectors, semi-transparent reflectors, thin layer pellicle reflectors, beam splitter cubes, or other suitable reflectors. In all these configurations, the light from different portions of display panels 6 or from different panels 6 can be polarized in such a way to increase the output light efficiency of the light-evolving cavity 1. More specific examples are given in the figures throughout this disclosure.

FIGS. 3A, 3B, and 3C illustrates some non-limiting instances of designs for Class I of field-evolving cavities 1. In general, the optical-tuning mechanism 7 may comprise at least one mirror 8 and at least one beam splitter plate 9. As can be seen from sections in FIG. 3, the specific cavity arrangement may be configured to reflect the optical path with the mirror 8, and the specific cavity arrangement may be further configured to reflect the optical path with the beam splitter plate 9, to pass the optical path through the beam splitter plate 9, or combinations thereof.

Section 5 of FIG. 3A illustrates an embodiment of a Class I of a field-evolving cavity 1 with a single display panel 6 at the bottom which produces only a single depth (included for theoretical support). The light directly travels out of the cavity exit pupil 2 without bouncing off any reflector or other optical surface(s). This is a cavity exit pupil 2 with zero order. The orange arrow shows the light bundle exiting the dashed line which is the cavity exit pupil 6 in all the figures in this disclosure. In all the figures, only the light that makes it out of the light-evolving cavity 1 is shown with red or blue arrows. The light that is wasted is not indicated in these drawings for simplicity.

Also for any beam splitter plate 9, the percentage of reflectivity can be chosen in such a way to maximize the brightness uniformity of all layers. This does not change the architecture of the design, and, thus, the reflectivity percentage is not specified through this disclosure. The reflectivity percentage can be assumed 50% for all the designs for simplicity.

Section 6 in FIG. 3A illustrates an embodiment of a Class I field-evolving cavity 1 comprising a single display panel 6 on the right wall which produces digital content simultaneously at two different depths. By incorporating a beam splitter plate 9 (half-mirror sheet) and a mirror 8 to combine and redirect light out of the cavity exit pupil 2. The light from the upper portion of the display panel 6 reflects off a mirror 8, passes through a beam splitter plate 9 and half of its intensity is outputted through the cavity exit pupil 2. The light from the lower portion of the display panel 6 reflects off the beam splitter plate 9, and half of its intensity is directed toward the cavity exit pupil 2. Therefore, this is a Class I of a field-evolving cavity 1 with a first order, and the intensity of each focal plane is half of the original intensity of the display panel 6. In some examples of this type of field-evolving cavity 1, one or more of the reflectors might be shifted up or down to change the desired depth that is output to the cavity exit pupil 2.

Section 7 in FIG. 3A illustrates an extension of Section 6 in FIG. 3A, in which a single display panel 6 is used to generate digital content simultaneously at three different depths. In some embodiments, the optical efficiency of the field-evolving cavity 1 may be different for different depths, and, therefore, the brightness of the display panel 6 could be adjusted to accommodate this variation. For example, if the beam splitter plates 9 have 50% reflection and 50% transmission, the light from the topmost part of the display panel 6 passes through two beam splitter plates 9, and, thus, its intensity is reduced to 25% of the intensity of the display panel 6; the light from the middle section passes through two beam splitter plates 9 and also has 25% of the intensity for the display panel 6, but the light from the lowermost section only passes through one beam splitter plate 9, and, therefore, the intensity is 50% of the intensity of the display panel 6. To compensate for this variation in intensity across focal depths, the brightness on the lowermost part could be reduced by 50% electronically through the signal that is given to the display panel 6. Such brightness adjustments can be applied to the various configurations in FIGS. 3 through 13 to provide uniform brightness for different layers of the light-field.

Section 8 in FIG. 3A illustrates the ultimate extension of Section 6 in FIG. 3A, in which a single display panel 6 is used to generate digital content at an arbitrary number of depths.

Section 9 in FIG. 3B illustrates an extension of Section 6 in FIG. 3A in which two field-evolving cavities 1 (each producing content at two depths) are combined to generate digital content simultaneously at four different depths.

Section 10 in FIG. 3B illustrates an extension of Sections 8 and 9 in FIGS. 3A and 3B, in which multiple cavities 1 illustrated in Section 8 in FIG. 3A are combined as illustrated in Section 9 in FIG. 3B to generate digital content simultaneously at a plurality of depths.

Section 11 in FIG. 3C illustrates an extension of Section 9 in FIG. 3, in which two display panels 6 are positioned back to back to provide more compact form factor.

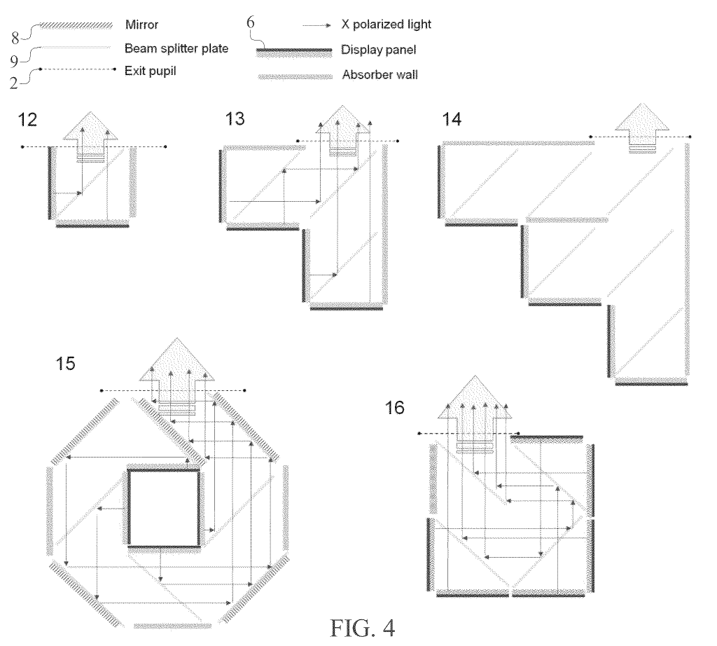

FIG. 4 shows non-limiting examples of designs for Class II field-evolving cavities 1 with the cavity exit pupil 2.

Section 12 in FIG. 4 illustrates an embodiment of a simple Class II field-evolving cavity 1 comprising two display panels 6 that are positioned perpendicularly to each other and that are combined with a single beam splitter plate 9. It has the benefit that the two display panels 6 can generate digital content simultaneously at two similar depths. By adjusting the position of one display panel 6, the depth separation between the two focal planes can be easily adjusted.

Section 13 in FIG. 4 illustrates an embodiment of a simple Class II of a field-evolving cavity 1 comprising four display panels 6 that are combined to generate digital content simultaneously at four different depths.

Section 14 in FIG. 4 illustrates the ultimate extension of Section 13 in FIG. 4, which generates digital content simultaneously at a plurality of different depths.

Section 15 in FIG. 4 illustrates an embodiment of a simple Class II field-evolving cavity 1 comprising four display panels 6 at the center that are combined to generate digital content simultaneously at four different depths.

Section 16 in FIG. 4 illustrates an embodiment of a simple Class II field-evolving cavity 1 comprising six display panels 6 that are combined to generate digital content simultaneously at six different depths.

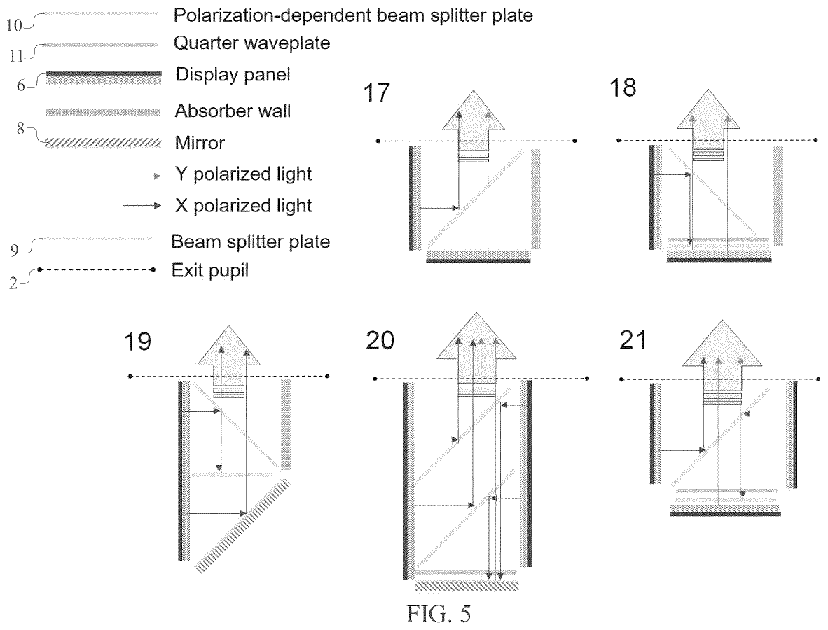

FIG. 5 shows examples of Class I field-evolving cavities 1 and Class II field-evolving cavities 1 with higher-order exit pupils 2. These non-limiting examples show how polarization and multiple reflections from the same surfaces can create more compact cavities with a larger number of output focal planes. In general, the optical-tuning mechanism 7 may further comprise at least one polarization-dependent beam splitter plate 10 and at least one quarter waveplate 11. As can be seen from the sections in FIG. 5 the specific cavity arrangement may be configured to reflect the optical path in a first polarization with the polarization-dependent beam splitter plate 10, to pass the optical path in a second polarization through the polarization-dependent beam splitter plate 10, or combinations thereof, wherein the first polarization is the optical opposite of the second polarization. The specific cavity arrangement may further be configured to switch the optical path from a first linear polarization to a second linear polarization with a combination of the quarter waveplate 11 and the mirror 8, wherein the first linear polarization is perpendicular to the second linear polarization.

Section 17 in FIG. 5 illustrates an embodiment of a Class II field-evolving cavity 1 comprising two polarized display panels 6 that are combined with a polarization-dependent beam splitter plate 10. The polarization-dependent beam splitter (PDBS) plate 10 is a beam splitter plate or a reflector sheet that reflects one polarization fully and fully transmits the other perpendicular polarization. It has the benefit that the two display panels 6 can generate digital content simultaneously at two similar depths. By adjusting the position of one display panel 6, the depth separation between the two focal planes can be easily adjusted. It also has the benefit that light loss is minimized by leveraging the polarization of the display panels 6 in conjunction with the PDBS plate 10.

Section 18 in FIG. 5 illustrates an embodiment of a Class II field-evolving cavity 1 with second order that uses a PDBS plate 10 and waveplate 11 to efficiently generate two different focal planes (image depths). In this embodiment, the light from the vertical display panel 6 has a horizontal polarization and hits a PDBS plate 10 that only reflects light with horizontal polarization. Therefore, this light (shown schematically by red arrows) moves upward and passes through a quarter waveplate 11 (shown in purple). This quarter waveplate 11 changes the horizontal polarization to clockwise circular polarization, and then it hits a half mirror on top of the horizontal display (shown in blue), which will then reflect it back with counter-clockwise polarization. The quarter waveplate 11 converts that counter-clockwise circular polarization to vertical linear polarization (shown schematically with red arrows). This light passes through the PBDS plate 10 and leaves through the cavity exit pupil 2. Light from the horizontal display panel 6 has counter-clockwise polarization, and by passing through the quarter waveplate 11, the light is converted to vertical polarization which then passes through the PBDS plate 10. This process of using a quarter waveplate 11 alongside a reflective surface 8 can be used extensively in many other configurations for field-evolving cavities 1 as shown in FIGS. 5 through 10. The functionality is identical to the one described for this configuration: the waveplate 11 together with the reflective surface 8 reflects and rotates the polarization by 90 degrees. Therefore, if light with a horizontal polarization goes through those layers, the light reflects back with vertical polarization and vice versa. If a vertically polarized light reflects from this structure, the light will be reflected with horizontal polarization.

Section 19 in FIG. 5 illustrates an embodiment of a Class II field-evolving cavity 1 with second order comprising a single display panel 6 that is combined with a series of beam splitter plates 9 and a mirror 8. It has the benefit that a single display panel 6 can be used to generate digital content simultaneously at two similar depths. By adjusting the position of the central beam splitter plate 9, the depth separation between the two focal planes can be adjusted. This embodiment is a Class I field-evolving cavity 1 since there are display panels 6 only in one dimension, and this embodiment has the cavity exit pupil 2 at second order since the light from the lower part of the display panel 6, reflects once from the lower beam splitter plate 9, and then again by the horizontal half-mirror (it will also pass through the lower beam splitter plate 9 before exiting). Higher order field-evolving cavities 1 can provide more flexibility in terms of design and form factor, but they tend to be less light efficient.

Section 20 in FIG. 5 illustrates an embodiment of a Class II field-evolving cavity 1 with second order comprising two display panels 6, combined with a series of PDBS plates 10. The light from left display panel 6 is x-polarized, which is reflected from the reflectors 8 to the cavity exit pupil 2. The light from right display panel 6 is x-polarized, which is reflected downward and goes through the waveplate 11, hits the bottom mirror 8, and goes through the waveplate 11 again, which will shift its polarization to y-polarization, which would then pass through the PDBS plates 10.

Section 21 in FIG. 5 illustrates an embodiment of a Class II field-evolving cavity 1 with second order that is configured such that the light from the right display panel 6 is x-polarized, so the light reflects from the PDBS plates 10. The light from bottom display panel 6 has a polarization rotated through the waveplate 11 and passes through the diagonal PDBS plate 10 to the cavity exit pupil 2. The light from the right-side display panel 6 is reflected downward by the PDBS plate 10, goes through polarization rotation through waveplate 11, is half-reflected by the beam splitter plate 9 at the bottom, and then passes through the diagonal PDBS plate 10 to the cavity exit pupil 2.

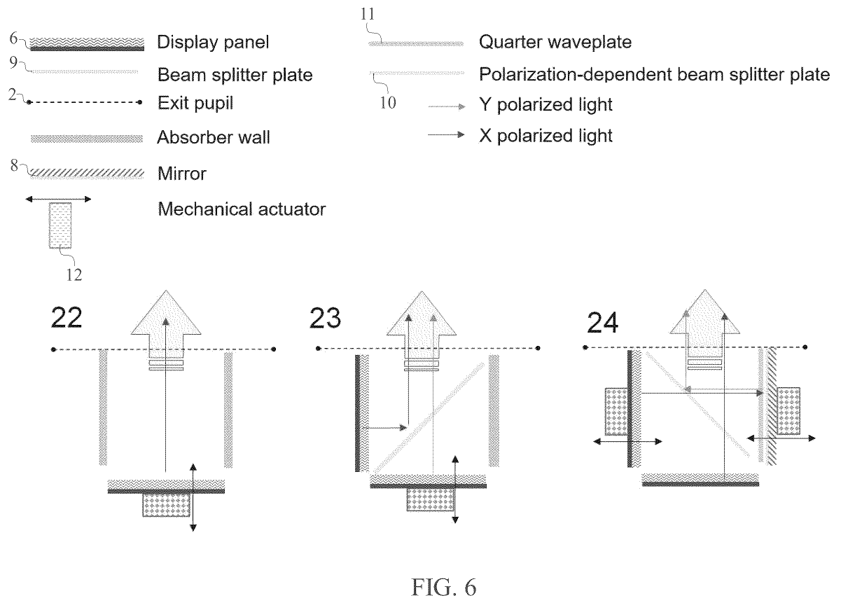

In reference to FIG. 6, the optical-tuning mechanism 7 may further comprise at least one mechanical actuator 12. As can be seen in the sections from FIG. 6, the specific cavity arrangement may be configured to translationally move the display panel 6 with a mechanical actuator 12, and/or the specific cavity arrangement may be configured to translationally move the combination of the waveplate 11 and the mirror 8 with another mechanical actuator 12.

Section 22 in FIG. 6 illustrates an embodiment of a Class I field-evolving cavity 1 comprising a single display panel 6 which is swept through a plurality of physical positions to generate digital content at a plurality of depths. Such a field-evolving cavity 1 can either be used as part of an accommodation display panel 6, where the position of the display panel 6 is adjusted to correspond to the user's vergence depth, it can be continuously swept while continuously updating the digital content displayed (to produce a light-field), or if the digital content is at a known depth, it can simply be set to match the perceived depth of the digital content. This mechanical movement can be combined with a curved relay to increase the optical range of variations in depth. This is usually necessary since mechanical translation with large range is usually not practical. Varieties of solutions can be considered for these mechanical translations such as mechanical stages, piezoelectric translators, or voice coils.

Section 23 in FIG. 6 illustrates an embodiment of a field-evolving cavity 1 combining the embodiment shown in Section 22 in FIG. 6 and the embodiment shown in Section 17 in FIG. 5, which simultaneously generates digital content at two different depths, one of which is dynamically adjustable.

Section 24 in FIG. 6 illustrates an extension of Section 23 in FIG. 6, which includes a movable mirror 8 to enable a more rapid translation of the dynamically adjustable focal plane. It simultaneously generates digital content at two different depths, one of which is dynamically adjustable. Faster transitions can be achieved by using higher order field-evolving cavities 1; however, in general, the speed of depth translation will be slow if mechanical motion is used. The speed of translation is typically directly a function of order. An example of Section 24 in FIG. 6 is the speed of tunability or translation that doubled since the light hits the right mirror 8 and therefore goes back a delta variation in the position of the mirror 8, or the display panel 6 is doubled through the roundtrip of the light. Simultaneous transition of the right display panel 6 and the left mirror 8 can quadruple the speed and range of depth variation in this example.

In reference to FIG. 7, the optical-tuning mechanism 7 may further comprise a plurality of switchable mirrors 13 that are in serial optical communication with each other and are positioned offset from each other. As can be seen from the sections in FIG. 7, the specific cavity arrangement may be configured to selectively alternate between reflecting the optical path with at least one specified mirror from the plurality of switchable mirrors 13 and passing the optical path through the specified mirror.

Section 25 in FIG. 7 illustrates an embodiment of a field-evolving cavity 1, which utilizes a polarized display panel 6 and a stack of polarization-dependent switchable liquid crystal mirrors 13 to produce digital content at a plurality of depths, each of which is determined by the switchable mirror 13 that is activated (the one which reflects the light). There are many technologies that provide functionality for a switchable mirror 13, and a non-limiting example of a switchable mirror 13 is a liquid crystal cell (LCC) placed on top of a polarization-dependent reflector. If the incident light has the same polarization as the polarization axis of the reflective surface, the light will reflect from the switchable mirror 13. If the LCC is turned on so that the LCC makes the incident light cross polarized with the reflective polarizer, the light passes through, and the mirror is rendered as transparent. There are other technologies for switchable mirrors 13 that use photorefractive or other electro-optical materials.

Section 26 in FIG. 7 illustrates a variant of Section 25 in FIG. 7, which utilizes a folded structure to double the depth separation imparted upon the output focal plane in comparison to the physical separation of the switchable mirrors 13. The depth that exits the cavity exit pupil 2 is defined by which switchable mirror 13 is turned on to reflect the light. These switchable mirrors 13 can be switched on and off with speeds comparable to the switching speed of liquid crystal material (tens of nanoseconds). In this architecture, each frame can be reflected from a different depth out of the field-evolving cavity 1 and therefore different layers in the light field can be scanned electronically and sequentially. Sequential scanning of the layers by turning on one of the switchable mirrors 13 at a time is not necessarily the most efficient way to scan the entire depth of light-field and one may use computational approaches to turn on and off switchable mirrors 13 inside the field-evolving cavity 1 in such a way as to increase overall light efficiency or brightness of the used depth. For example, if there is content only on the closest depth, there is no need to allocate more empty frames to another deeper depth. In other words, the signal to feed the display panel 6 and the switchable mirrors 13 can be processed in such a way as to maximize the frame rate and brightness dynamically at active depths.

Section 27 in FIG. 7 illustrates is an embodiment of a field-evolving cavity 1, which uses a microlens array to collimate a display panel 6 and to project digital content onto a stack of switchable diffusers. This embodiment produces digital content at a plurality of depths, each of which is determined by which diffuser is set to be diffusive. In addition, if the switchable diffusers are driven in such a way that a spatially varying diffusion is achieved, it is possible to produce a diffusive surface which is non-planar, thereby creating an output focal plane which is non-planar.

The spatially varying depth of this output focal plane can then be dynamically adjusted to match the spatially varying depths of the digital content being displayed. There are many technologies available for switchable diffusers; most of these technologies depend on polymer stabilized cholesteric texture (PSCT) light shutter technology. Another way to realize Section 27 in FIG. 7 is to use polarization-dependent diffusers, which scatter light at one polarization and transmit the light at the other perpendicular polarizations. This will require a layer of liquid crystal on top of the lenslet to rotate polarization, which would correspond to different diffusers diffusing the light at different depth. Although this is theoretically viable, such arrangement would most likely produce haze artifact for deeper layers.

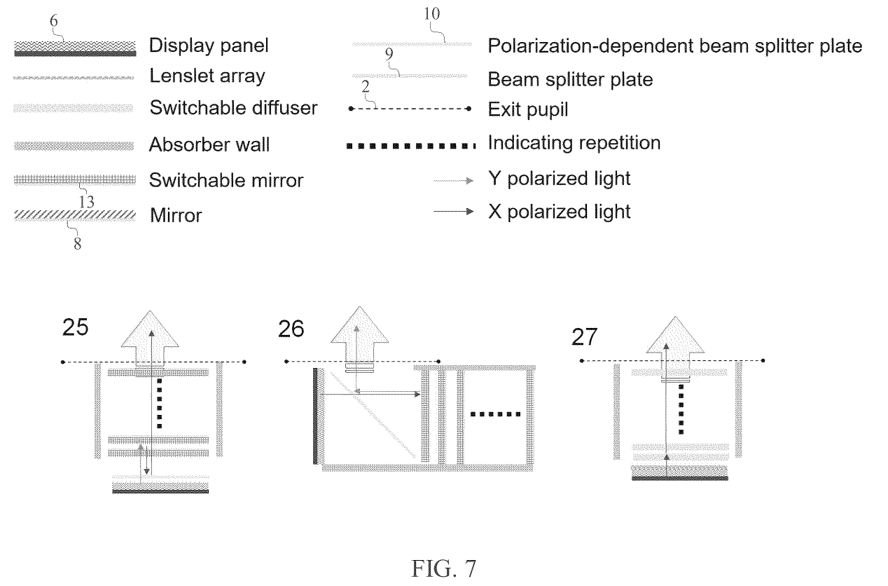

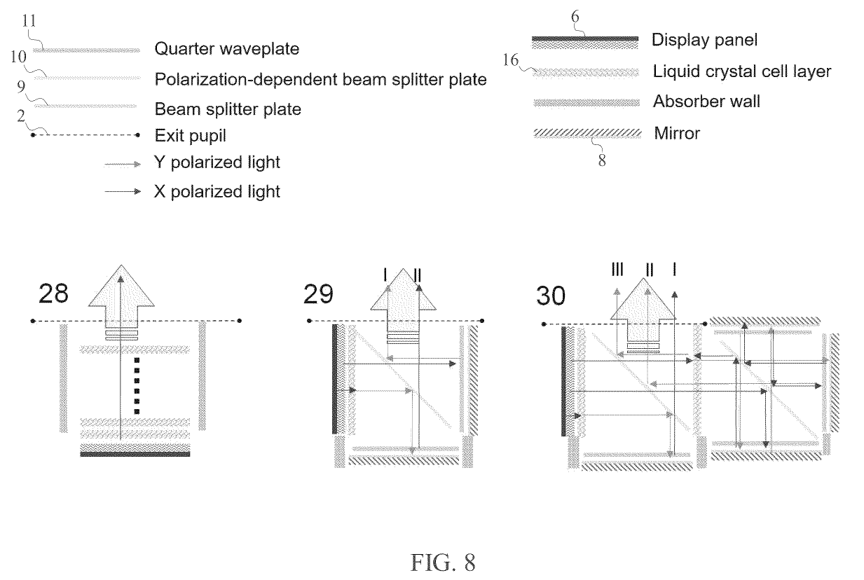

In reference to FIG. 8, the optical-tuning mechanism 7 comprises at least one liquid crystal cell layer 16. As can be seen from the sections in FIG. 8, the specific cavity arrangement may be configured to switch the optical path from a first linear polarization to a second linear polarization with a liquid crystal cell layer 16, to tune a refractive index of the optical path with the liquid crystal cell layer 16, or a combination thereof, wherein the first linear polarization is perpendicular to the second linear polarization.

Section 28 in FIG. 8 illustrates an extension of Section 25 in FIG. 7, which generates different depths by virtue of the birefringence of transmissive liquid crystal cell layers 16 that are positioned on top of the display panel 6. As more or fewer of the stack of liquid crystal cell layers 16 is activated, the apparent refractive index between the display panel 6 and the cavity exit pupil 2 can be dynamically tuned. As such, this extension can generate digital content at a plurality of different depths. The amount of required variation in refractive index depends upon the design of the optical relay mechanism 3 that couples to the cavity exit pupil 2. If the optical relay mechanism 3 magnifies perceived depth, small variations in the optical path can result in large shifts in the focal plane depth that are perceived by the user.

Section 29 in FIG. 8 illustrates an alternative to Section 28 in FIG. 8, which can provide significantly larger depth steps and thereby a larger depth variation range for the focal plane compared to Section 25 in FIG. 7. It is an embodiment of a Class I field-evolving cavity 1 with a single polarized display panel 6, light from which passes through a liquid crystal cell layer 16 capable of rotating incident polarization. Because of the construction of the rest of the field-evolving cavity 1 (with a polarization-dependent beam splitter plate 10 and quarter waveplates 11/mirrors 8 as illustrated in FIG. 8), it is possible to use the liquid crystal cell (LCC) layer 16 to switch between two output depths. In some embodiments, the LCC layer 16 does not have a 2D matrix on it and is essentially a LCC layer 16 that rotates the polarization by 90 degrees once biased. As such, it can generate digital content at two different planes, the selection of which is determined by the state of the liquid crystal cell layer 16 (and the cavity's physical construction). In the illustrated embodiment, the display panel 6 produces horizontally polarized light (blue arrows). If the LCC layer 16 is off, the light passes through the LCC layer 16 with the same polarization, then passes through the polarization-dependent beam splitter plate 10, then hits the quarter waveplate 11 and reflector 8, then reflects with vertical polarization, then hits the beam splitter plate 9, and exits the cavity exit pupil 2 (Beam I). If the LCC layer 16 is on (biased with electricity), then the polarization rotates 90 degrees and becomes vertical, reflects from the beam splitter plate 9, goes upward, reflects off the quarter waveplate 11/mirror structure 8 resulting in horizontal polarization, and passes through the polarization-dependent beam splitter plate 10 (Beam II).

Section 30 in FIG. 8 illustrates an extension of Section 28 in FIG. 8, which allows for one display panel 6 to generate digital content at three different depth planes, the selection of which is determined by the state of two liquid crystal cell layers 16 (and the physical construction of the field-evolving cavity 1). In addition, it can provide significantly larger depth steps and thereby a larger depth variation range for the focal plane compared to Section 25 in FIG. 7. Each liquid crystal cell layer 16 acts like a 2D optical valve that preserves the angular information and defines which path the light is going to take depending on the state of its polarization. Based on the state of the LCC layers 16, the three depths of I, II, and III can be generated. For example, considering that the display panel 6 has horizontal polarization, in this design, depth I is generated when LCC1 is on (LCC2 is not used for depth I). Depth II is generated when LCC1 is off and LCC2 is off. Depth III is be generated when LCC1 is off and LCC2 is on. Theoretically, this design can be extended to an infinite number of field-evolving cavities; however, each time another field-evolving cavity is added, some portion of the light will be lost, and the efficiency will be reduced.

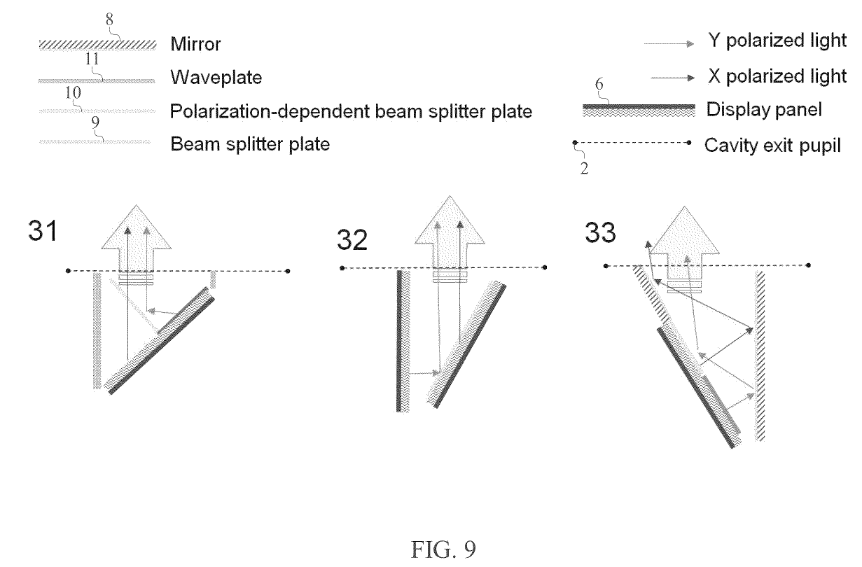

Section 31 of FIG. 9 illustrates a compact wedge cavity extension of Section 12 of FIG. 4, which uses a single display 6 instead of two display panels 6 to generate digital content simultaneously at two similar depths. By adjusting the position of the single polarization-dependent beam splitter plate 10, the depth separation between the two focal planes can be easily adjusted. It also has the benefit that light loss is minimized by leveraging the polarization of the display panel 6 in conjunction with the polarization-dependent beam splitter plate 10 and a waveplate 11.

Section 32 of FIG. 9 illustrates a compact Class II variation of Section 12 of FIG. 4, which uses two polarized display panels 6 and a polarization-dependent beam splitter plate 10 to generate digital content simultaneously at two similar depths. By adjusting the position of the display panels 6, the depth separation between the two focal planes can be easily adjusted.

Section 33 of FIG. 9 illustrates is a compact Class I wedge for a field-evolving cavity, which uses a polarized display panel 6 to generate digital content simultaneously at two depths. The angle may cause the light to exit the cavity exit pupil 2 at a desired angle.

### Depth and Brightness Enhancement Mechanisms

The depth of each layer in the light field can be tuned by using glass or other high refractive index materials within the field-evolving cavity 1 or at the cavity exit pupil 2. Additionally, the brightness of the layers can be enhanced by using prismatic films on the display. The display panels 6 in the field-evolving cavity 1 usually have a Gaussian wide-angle profile with peak intensity at the center; this is not always beneficial in a cavity-based light-field where the reflection from a display panel 6 might be at an oblique angle. Placing prismatic films on the display panel 6 can help to tilt the peak intensity of the gaussian profile to a certain desired angle to get brighter output for that layer of the screen. The reason that high refractive index glass windows reduces the depth is that it refracts the light into a smaller cone than the original cone of the light, and, therefore, the perceived depth appears to be slightly smaller, or less deep.

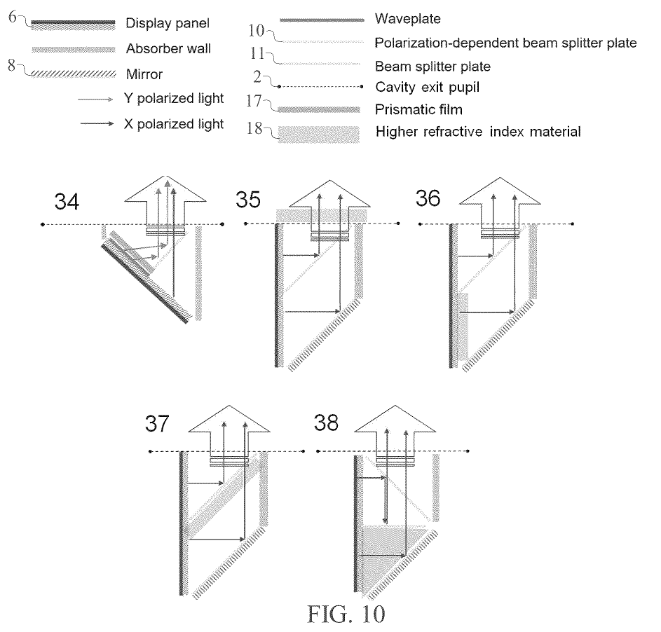

In reference to FIG. 10, the optical-tuning mechanism 7 may further comprise at least one prismatic film 17 and at least one piece of higher refractive index material 18. As can be seen from the sections from FIG. 10, the specific cavity arrangement may be configured to enhance a brightness of the optical path with the prismatic film 17, and/or the specific cavity arrangement may be configured to lower a depth of the focal plane along the optical path with the piece of higher index material 18.

Section 34 of FIG. 10 illustrates an example case where a prismatic film 17 can increase the brightness by tilting the peak of the gaussian profile of the intensity toward the reflector. Prismatic films 17 always help if the cavity exit pupil 2 looks at the display panel 6 in any angle other than 90 degrees angle.

Section 35 of FIG. 10 illustrates an example of Class I field-evolving cavity 1 with a first order of the cavity exit pupil 2, where both of the depths are perceived to be slightly less deep inside the field-evolving cavity 1 due to high refractive index 18 at the cavity exit pupil 2.

Section 36 of FIG. 10 illustrates is an example of Class I field-evolving cavity 1 with a first order of the cavity exit pupil 2, where deeper focal plane has become slightly less deep to the cavity exit pupil 2 due to high refractive index 18 on the display panel 6.

Section 37 of FIG. 10 illustrates is an example of Class I field-evolving cavity 1 with a first order of the cavity exit pupil 2, where deeper focal plane has become slightly less deep to the cavity exit pupil 2 due to high refractive index 18 on the back of the reflector 8 for the closer depth.

Section 38 of FIG. 10 illustrates is an example of Class I field-evolving cavity 1 with a first order of the cavity exit pupil 2, where deeper focal plane have become notably less deep to the cavity exit pupil 2 due to high refractive index 18 on the entire lower section of the field-evolving cavity 1. In essence, the bottom reflector 8 is replaced with a high refractive index prism 18.

### Relay Mechanisms and Application Modalities

As mentioned previously, the cavity exit pupil 2 delivers light into a relay mechanism 3, resulting in different reference apexes of divergence for different focal planes being presented to the user. The relay mechanism 3 can be an off-axis visor, a geometrical or diffractive waveguide, a birdbath design beam splitter, or any other suitable relay means.

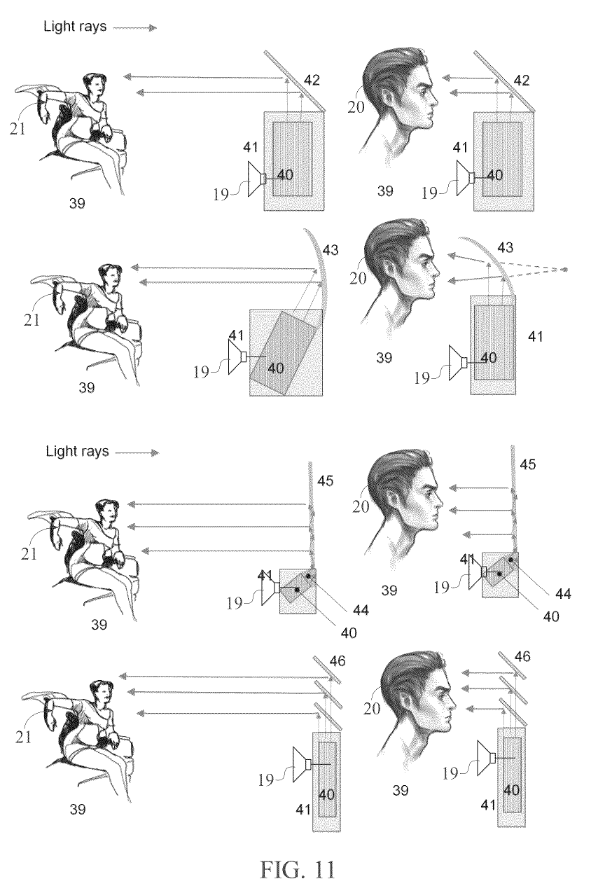

FIG. 11 and the following descriptions provide non-limiting examples of relay mechanism 3 which can be used to direct the output of a field-evolving cavity 1 to the viewer. In one example, the light exits the cavity exit pupil 2 onto a visor and moves toward the eye. In another example, the light exits a smaller cavity and is fed to a large-size waveguide that then redirects the light toward the viewer.

In reference to FIG. 11, the diagram showing how the output of the field-evolving cavity 1 can be relayed to the viewer as part of an entertainment system or a magnified monitor. The left column shows entertainment system modalities, and the right column shows magnified near-head display modality. In general, a near-head mount 20 may be operatively coupled to the system enclosure 5, wherein the near-head mount 20 is used to position the system enclosure 5 adjacent to a user's head. Moreover, an entertainment stand 21 is operatively coupled to the system enclosure 5, wherein the entertainment stand 21 is used to position the system enclosure 5 offset from a user's head. Furthermore, at least one audio output device 19 is electronically connected to the display panel 6.

Reference 39 in FIG. 11 illustrates the viewer either in near-head modality 20 or entertainment system modality 21 where the viewer is farther than 60 centimeters (cm) from the display.

Reference 40 in FIG. 11 illustrates a generalized display cavity (i.e. the at least one field-evolving cavity 1) producing digital content (stereoscopic or 2D) at one or more depths.

Reference 41 in FIG. 11 illustrates the casing (i.e. the system enclosure 5) of the at least one field-evolving cavity 1 that holds the rest of the electronics of the system.

Reference 42 in FIG. 11 illustrates an example of an angled reflector relay (i.e. the relay mechanism 3) where a reflective, semi-reflective or switchable mirror surface is used to relay the cavity exit pupil 2 to the enclosure exit pupil 4 and therefore the viewer.

Reference 43 in FIG. 11 illustrates an example of a curved angled reflector relay (i.e. the relay mechanism 3) where a curved reflective, semi-reflective, or switchable mirror surface is used to relay the cavity exit pupil 2 to the enclosure exit pupil 4 and therefore the viewer. The curvature of this relay can change the depth of the content coming from the original depth of the cavity to further or closer distances.

Reference 44 in FIG. 11 illustrates a coupling optics that couples the cavity exit pupil 2 to the entrance pupil of the waveguide (i.e. the relay mechanism 3).

Reference 45 in FIG. 11 illustrates a geometrical or diffractive waveguide (i.e. the relay mechanism 3), which redirects the output of FE Cavity (made with LCOS and reflectors or DMD and reflectors or LCD panels and reflectors or array of projectors) to the viewer. These waveguides can be multimode geometrical, diffractive, or real single mode-confined waveguides.

Reference 46 in FIG. 11 illustrates a compressed relay system (i.e. the relay mechanism 3) that will be further detailed in the next section of this disclosure. The compressed relay system helps to have more compact form-factor for the display.

### Compressed Designs

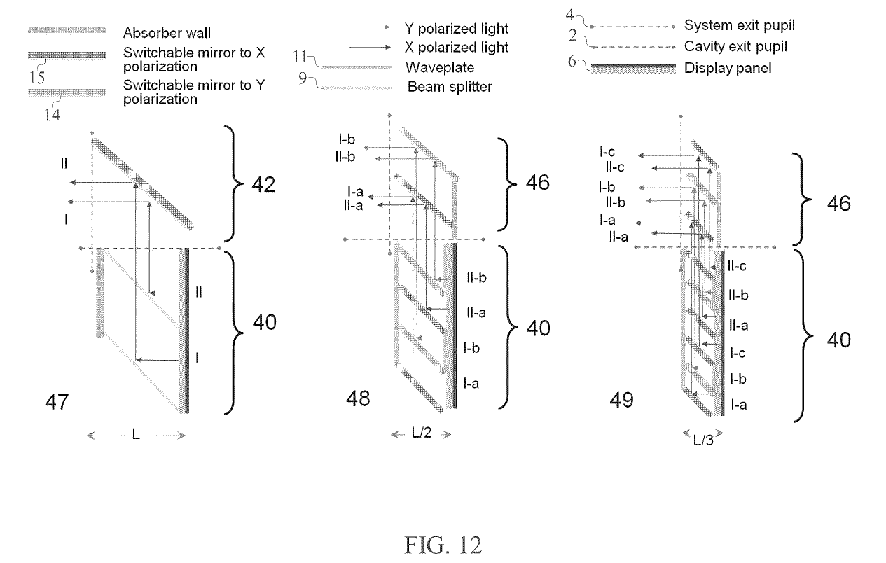

The single reflectors can be bulky both inside the FE cavity 1 and as the relay. FIG. 12 shows few non limiting examples of such compressed designs based on spatial stacking of switchable mirrors.

In reference to FIG. 12, an operative combination of the at least one field-evolving cavity 1 and the relay mechanism 3 may comprise a plurality of switchable mirrors that are in serial optical communication with each other and are positioned offset from each other. Moreover, the plurality of switchable mirrors may comprise a plurality of first switchable mirrors 14 and a plurality of second switchable mirrors 15 so that the plurality of first switchable mirrors 14 is interspersed amongst the plurality of second switchable mirrors 15. As can be seen in the sections of FIG. 12, the specific cavity arrangement being configured to selectively alternate between reflecting the optical path in a first polarization with at least one specified first switchable mirror from the plurality of first switchable mirrors 14 and passing the optical path through the specified first switchable mirror, while the specific cavity arrangement is further configured to selectively alternate between reflecting the optical path in a second polarization with at least one specified second switchable mirror from the plurality of second switchable mirrors 15 and passing the optical path through the specified second switchable mirror. This allows the plurality of first switchable mirrors 14 and the plurality of second switchable mirrors 15 to be configured to compress an occupying volume of the operative combination of the at least one field-evolving cavity 1 and the relay mechanism 3. Section 47 of FIG. 12 shows an example system where there is no compression with Class I FE cavity 1 and two depths, similar to Section 6 in FIG. 3A. The light exits the cavity exit pupil 2 (shown by blue dashed line), reflects from Reference 42 in FIG. 12 (i.e. the relay mechanism 3), and exits the enclosure exit pupil 4 (shown in the red dashed line). The deeper light I is coming from depth I, and the light II is coming from a closer distance inside the field-evolving cavity 1. The system is obligated to have minimum thickness of L obligated by the dimensions of the display panel 6. For the same dimensions of the display panel 6, Section 48 of FIG. 12 reduces the thickness to half (L/2). This compression is obtained by having a stack of relays which are transparent relative to which other either by means of temporal switching of the switchable mirrors or by polarization. Therefore, in Section 48 of FIG. 12, the deeper depth I has two sections I-a and I-b which are relayed at two different distances; the distances in relay work in such a way that I-a and I-b both end up having the same depth as depth I but will span the same size for the enclosure exit pupil 4 as in Section 47 of FIG. 12. The same thing is happening for the closer depth II. The depth is diced into two relays which expand the enclosure exit pupil 4 but have less thickness. This approach can be extended for further compression. Moreover, Section 49 in FIG. 12 shows the case where the thickness in relation to Section 47 of FIG. 12 is compressed by factor of three. Here each depth level is spatially multiplexed to three sections which are compensated by the height of the three relay switchable mirrors 14, 15. For example, the paths that I-a and I-b and I-c travel to the enclosure exit pupil 4 (shown in the red dashed line) are equal, and, thus, all of them have the same depth as depth I. However, they exit at different heights, therefore expanding the enclosure exit pupil 4 back to the size of the enclosure exit pupil 4 in Section 47 of FIG. 12.

### Example Prototype

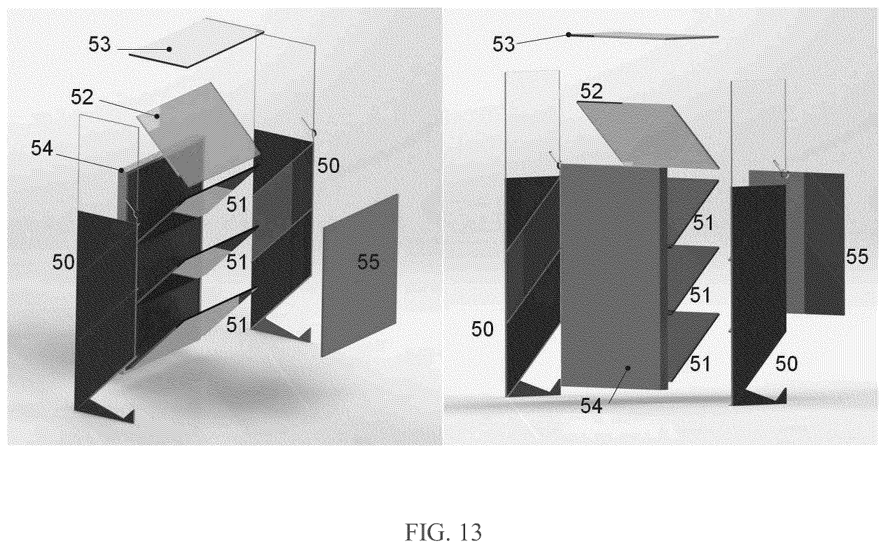

FIG. 13 shows the exploded 3D model of a prototype system, previously shown with no details in FIG. 1, with three depths from the back on the left and from the front on the right. The components are as below:
Reference 50 in FIG. 13 (i.e. components of the system enclosure 5) are side holders of the assembly. Reference 51 in FIG. 13 (i.e. components of the optical tuning mechanism 7) are reflective or semi-reflective surfaces. Reference 52 in FIG. 13 is a simple reflective mirror working as the relay mechanism 3. Reference 51 in FIG. 13 (i.e. component of the system enclosure 5) is a top cap just for protection of the relay mechanism 3. Reference 54 in FIG. 13 (i.e. the display panel 6) is an LCD panel that is divided at three depths. Reference 55 in FIG. 13 (i.e. component of the system enclosure 5) is a back cover of the FE cavity 1.

### Advantages and Improvements Over Existing Methods

The arrangements, methods, and assembly of components in this description confer a variety of advantages and improvements over existing 3D systems:
Ergonomic advantages and improvements
   Accommodation-vergence conflict mitigation—the present invention described herein can produce digital content at multiple depths with true monocular optical wavefront. The flexibility of display digital content at multiple depths enables the presentation of digital content at an optical depth which matches or is similar to the binocular disparity depth cue presented to the viewer, thereby helping to resolve any accommodation-vergence conflict experienced by the viewer. Mitigating accommodation-vergence conflict makes the digital content more comfortable to view for extended periods of time and increases the sense of realism experienced by the user viewing the digital content.
   Size reduction—Because the present invention allows for folding of optical paths, it offers flexibility in terms of packaging compared to systems that use projectors. This enables smaller systems.
   Unlike autostereoscopic 3D systems, which are limited in view zone distance and angle, and sometimes allow only few viewers to see the 3D content, the present invention allows up to a 150-degree (depending on number of depths) viewable angle and does not have limitation in number of users.
   The FE cavities 1 can be combined with any type of panels and light engines so they are not limited to a specific technology; if needed, they can also use autostereoscopic displays as an engine to enhance their performance in depth accuracy.
   Reduced cost—As opposed to using eye-tracking-based accommodation displays or holographic displays, the present invention can utilize readily available components (flat display panels) which are ready for mass production, significantly reducing overall system cost and technical challenges.
   Since a FE cavity 1 system allows true optical depth, they allow the enclosure exit pupil 4 to sit very close to the eye without any eye fatigue since the true optical depth of the images can be far back. Unlike stereoscopic displays, this opens a whole new set of possibilities for near-head displays where the size of the display can be magnified with no need to wear anything or have a large screen.
   For most of the designs with a passive glass reflector or even switchable mirrors herein, the images provided by FE cavities 1 have no artifacts such as haze, color nonuniformity, distortion, and moiré artifacts.
Performance advantages and improvements
   Bandwidth reduction—The present invention as described herein allows for solving or mitigating accommodation-vergence conflict without having to present the entire 5D plenoptic function to the viewer. This reduces the complexity of content rendering and can improve system frame rates compared to full light-field displays. The bandwidth can be reduced by orders of magnitude.
   Optical efficiency flexibility—The present invention is flexible in that if optical efficiency is a priority, a design can be chosen that has high light throughput. If display brightness is not needed, additional flexibility exists to add more display planes or use simpler cavity designs.
   Spatial resolution flexibility—The present invention is flexible in that spatial resolution can be maintained by using multiple display panels 6. If spatial resolution is not needed (for instance, if individual pixels are already not resolvable by the user), the present invention can utilize unnecessary spatial resolution to render a different depth plane, improving the user experience.
   Expandability—FE cavities 1 are conveniently expandable in architecture, number of planes and expansion to different display systems.
   Compatibility—The present invention introduced herein has significant advantages in compatibility, both on the software level and on the hardware level. At the software level, since the light source can be ultimately a 2D screen, the feed to the display system can be easily fed with conventional standard signals. Also, this simplifies the rendering as there is no fundamental need for significant computational processing of the input due to depth providing optics. The hardware architecture is integral to a wide variety of existing 2D display systems.
Functional advantages and improvements
   Monitor magnification—Since the depth of the systems disclosed herein are true optical depths, the eye can accommodate and view these 3D contents with no discomfort at any given distance of the display. For example, if the display is 20 cm away from the head, but the depth that is shown is still 2 meters, the viewer sees the image as being 2 meters away and can use the monitor even at such a close distance. This helps to magnify small sized monitors using true optical depth provided by disclosed systems.
   Heads up displays—The relay can be semitransparent since the depth can be much further than the actual position of the display, which makes a perfect case for large-scale superposition of the image and the real world, especially in the context of the heads up display.
   Entertainment—The light-field experience provides a better sense of realism due to accurate optical depth and artifact free images. This can be used for home entertainment, gaming, and commercial entertainment applications.

### Commercial Applications

Many commercial applications become possible with the dramatic accuracy in depth, transparency of the screen, and sense of immersion. What follows is a non-exhaustive list of possible applications:
Navigation
   Turn-by-turn directions while driving/piloting/etc., using heads up displays without having to look away from the road or fumble with a phone or separate navigation device.
Medical
   Better investigation of 3D data files using the light-field displays.
Workplace Ergonomics
   Magnified displays can provide a convenient replacement for large displays without the need to wear any hardware or the need to have a large screen. The 3D nature of the display can provide a volume for office work with pixel accuracy that is equal to the standard monitors today.
Entertainment
   The layered nature of FE cavities 1 provides ease in content generation from game and video industries. This is because rendering in a few layers to provide 3D effect is much easier (less computationally demanding) than rendering the entire 3D environment.
   The FE cavities 1 are well suited for stand-alone game machines since the true depth attracts viewers due to new experiences.
Design
   Previewing the look and feel of objects which have yet to be physically prototyped, and visualizing content for modeling and design in AR or VR without having to wear headsets. This is very important since developers cannot wear headset for many hours, but they can use the present invention with true optical depth.

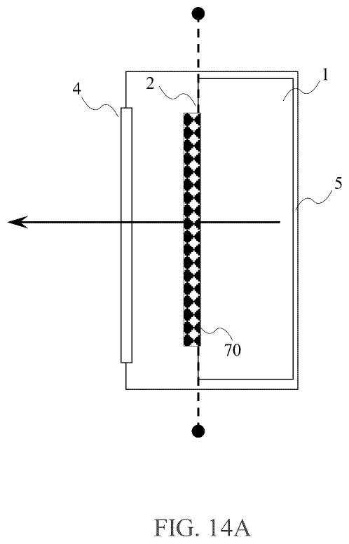

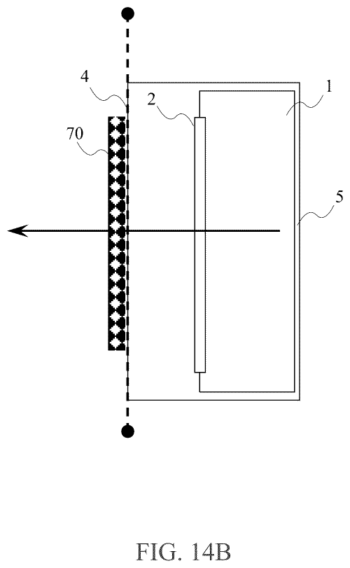

In any of the embodiments of the field evolving cavities described above, aperture optics 70 can be added to assist and modify the optical properties of the light of the optical path. FIG. 14A and FIG. 14B show two exemplary examples.

In FIG. 14A, light that exits the field-evolving cavity 1 passes through the aperture optics 70 positioned at the cavity exit pupil 2. The light modified by the aperture optics 70 then exits the system enclosure 5 through the enclosure exit pupil 4. Similarly with the exemplary example in FIG. 14B, the field-evolving cavity 1 emits light through its cavity exit pupil 2. The light passes through and is modified by the aperture optics 70 positioned at the enclosure exit pupil 4 and travels to a viewer.

The aperture optics 70 can comprise any number of light modifying devices including, but not limited to, antireflection layers, prismatic films 17, privacy layers, absorptive polarizers, or micro-curtain layers. The aperture optics 70 may further be used to modify the ambient light that is directed toward the user from the external environment. As an exemplary example, an anti-reflection layer can be used as an aperture optic 70 to remove stray reflections that would otherwise enter the viewer's eyes. Aperture optics 70 may have the further function of protecting the components within the system enclosure 5 from the external environment. In some embodiments, aperture optics 70 can be placed at both the cavity exit pupil 2 and the enclosure exit pupil 4.

In this disclosure, the field-evolving cavity can produce a light-field display, or a subsampled light-field display, i.e., a light-field display that only approximately replicates the full light-field emanating from a physical three-dimensional scene. For example, fractional light-field display may produce a single virtual image, corresponding to a single focal plane or virtual depth.

In some embodiments, the field-evolving cavity 1 is further comprised of one or more semi-reflective elements 71 and one or more reflective element 72. In some embodiments of the present invention, these reflective elements 72 and semi-reflective elements 71 are configured such that the light of the optical path is at least partially folded onto itself to selectively tune a virtual depth location of a virtual image presented to a viewer. In other words, the field-evolving cavity 1, the reflective elements 72 and semi-reflective elements 71 are configured so a portion of the optical path is folded back onto the original optical path in order to adjust a depth of the focal plane along the optical path. This folding of the optical path upon itself allows the present invention to further tune the virtual depth location of the virtual image. Further embodiments, include switchable mirrors or mechanical actuators within the field-evolving cavity 1, configured to further tune the virtual depth location of the virtual image.

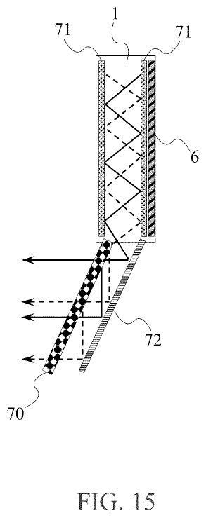

FIG. 15 shows a further embodiment of a field-evolving cavity 1 in which the semi-reflective elements 71 of the system are segmented to produce multiple depths through an extended aperture optics 70. In some embodiments, the display panel 6 itself can be segmented. In other embodiments, the reflective 72 or semi-reflective 71 optics may be segmented.

In this disclosure, an element that is “segmented” has a property that varies across the surface of the element. A segmented semi-reflective element, for example, is a semi-reflective element whose reflection coefficient or reflectivity various across its surface. The variation can be smooth, continuous, piecewise constant, or piecewise smooth. A segmented display panel is a display panel that shows different image content in various regions of the display panel. For example, a display panel that is segmented into two regions can show a first image and a second image. In this way, light emitted from, transmitted through, or reflected by different segments of segmented elements can travel different paths through the display system.

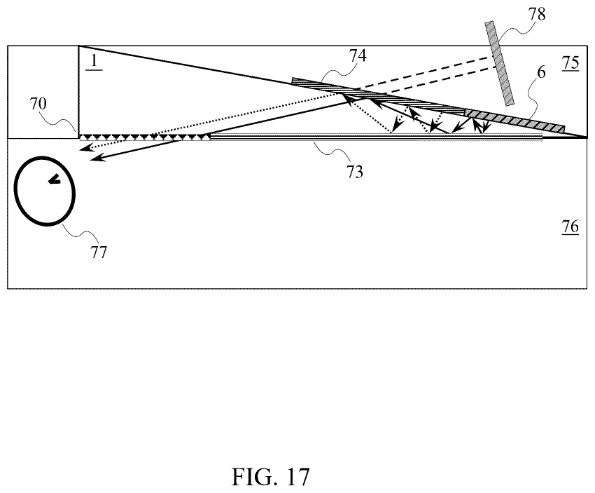

This segmentation of components creates a number of segmented elements, such that a segmented display panel 6 may be segmented into a first segmented element and a second segmented element. There is no limit to the number of segmented elements created by a segmented component. Further, in the same manner the reflective 72 optics or the semi-reflective 71 optics can also be segmented into a first segmented element and a second segmented element. Any of the components within the present invention may be segmented in this same manner. Exemplary embodiments with segmented elements are shown in FIG. 15 and FIG. 17.

Further, the reflective 72 optics or the semi-reflective 71 optics may have gradient properties, such as a gradient reflectivity. The reflective 72 optics or the semi-reflective 71 optics, including segmented optics, can further be polarization-dependent, such that after interacting with the polarization-dependent element, the light of a first polarization travels a first optical path, and the light of a second polarization travels a second optical path.

As shown in FIG. 15, the light of the optical path may be guided along a cavity created between two or more reflectors, elements, optics, or components which constitute a light pipe. The light of the light pipe being guided down the cavity of the light pipe exiting the light pipe though aperture optics 70. The light being directed to the viewer.

In further embodiments a light pipe can be created with segmented elements, such as a first segmented element and a second segmented element. In one embodiment, the first segmented element and a second segmented element are comprised of polarization-dependent elements. The polarization-dependent elements of the first segmented element and a second segmented element be configured such that the light of a first polarization is guided along a light pipe along a first optical path and the light of a second polarization is guided along the light pipe along a second optical path. Thereby the light pipe produces a plurality of virtual images at a plurality of depths. In some embodiments, the light paths corresponding to the different segmented elements form images at the same depth but different lateral positions, such that together they form a single virtual image with extended aperture or field of view. In some embodiments, this polarization-dependent element light pipe is embedded or integrated into a vehicle.

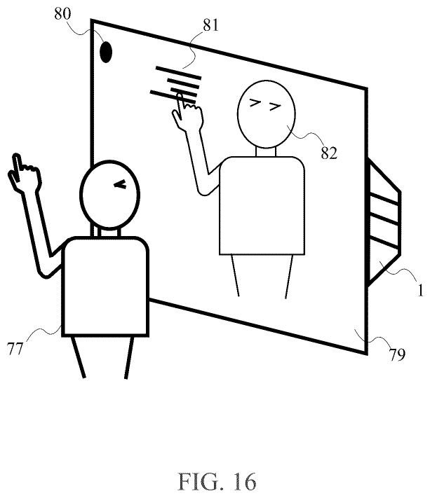

The further embodiment shown in FIG. 16 has a field-evolving cavity 1 that has an exit aperture in optical communication with to a large mirror 79. The mirror can function partly as an aperture optic. The embodiment further comprises a gesture sensor 80, a depth camera 80, or both. The gesture sensor 80 or depth camera 80 being coupled or integrated into the display system. The gesture sensor 80 or depth camera 80 observes the viewer 77, such that the display system can capture, incorporate, or interpret the motions, positions, and gestures of the viewer 77. The gesture sensor 80 or depth camera 80 relays the information about the viewer 77 to the display system. The display system is then able to use this information to generate and display text or other augmentation effects dynamically as a virtual image 81. In some embodiments, the text or augmentation effects can be generated from other sources, and they can still be manipulated by the viewer through the depth camera 80 or gesture sensor 80.

In this embodiment, the field-evolving cavity 1 is configured to produce a virtual image 81, the virtual image 81 including any number of items such as but not limited text or images. This virtual image 81 is produced by the field-evolving cavity 1 so that the virtual image 81 appears at a virtual depth that is similar to the reflection 82 of the viewer in the mirror. In other words, when the viewer looks at their reflection 82 in the mirror, the virtual image 81 that is produced by the field-evolving cavity 1 appears to be at the same depth or appears to be on the same plane as the reflection 82 in the mirror.

In some embodiments, the field-evolving cavity 1 can further comprise a retroreflective or a retrorefractive element. The retroreflective or retrorefractive element can be configured so that the virtual image 81 appears closer to the viewer 77 compared to the viewer's 77 physical distance to the display. Thereby, the text or augmentation effects of the virtual image 81 appear at the same depth as the viewer's image. The viewer can then interact with the virtual images 81 via the gesture sensor 80 or depth camera as if the text or augmentation effects of the virtual image 81 are hovering in mid-air.

FIG. 17 shows a further embodiment where the field-evolving cavity 1 is embedded or integrated into the roof 75 or ceiling of a vehicle 76. In this further embodiment, which is similar to embodiment 33 of FIG. 9, the display panel 6 emits light into the field-evolving cavity 1, which can have a first element 73 and a second element 74. Both the first element 73 and the second element 74 can be reflective elements or semi-reflective elements which are positioned at angles of less than 45 degrees relative to each other. This angle can be designed arbitrarily. In some embodiments, the display panel itself can be segmented; in some embodiments, the first element or the second element can be segmented. In some embodiments, the segmented properties can be switchable in time, such that light travels a first path at a first time, and subsequent light travels a different path at a second time. In some embodiments, no elements are segmented. As the light is reflected between the two reflective elements, the angle at which it travels becomes shallower. This creates a light pipe that directs the light out of the exit of the display system towards a viewer 77, who sees a virtual image 78 corresponding to a shallower line of sight. In some embodiments, the virtual image is tilted at an angle different from that of any of the components of the display system and from that of the roof or ceiling. The viewer does not see a virtual image when looking straight up into the roof of the vehicle. In some embodiments, an aperture optic 70 is used. In some embodiments a relay mechanism 3 is used. In some embodiments, a component of the display system, such as the second segmented element, functions simultaneously as an aperture optic, relay mechanism, and optical tuning mechanism, or a subset thereof.

In some embodiments, the light path can be impacted by polarization-dependent elements. For example, a semi-reflective element can comprise a polarization-dependent grating, which directs light of a first polarization along a first path and light of a second polarization along a second path. The polarization of the light can be changed using quarter-wave plates and reflective polarizers.

In some embodiments, the field-evolving cavity can further comprise retroreflecting or retrorefracting elements, such that the virtual images appear closer to a viewer rather than farther away. Similar to the embodiment in FIG. 16, gesture cameras or depth sensors can be coupled to the display system, such that a viewer can interact with the virtual images. In some embodiments, the display system is transparent or semi-transparent for a see-through effect, such that a user can see simultaneously the display content and the environment behind the display system. In some embodiments, cameras capture information about the environment outside the vehicle, and the display system displays that information, for a video see-through effect.

The embodiment in FIG. 17 is an example of a wedge-type cavity, described in FIG. 9, but it can also be configured as other classes or orders of field-evolving cavities, such that the light path folds onto itself exactly or approximately. In such cavities, light can be folded when it experiences multiple reflections from a single element.

The embodiment of FIG. 17 may be integrated into portions of a vehicle. Although the embodiments described herein refer to an automobile or car, the vehicle can take on other forms, including, for example and not limitation, a car, a truck, a motorcycle, a tricycle, a tank, an aircraft, or a water vessel.

It is important to note that each point of the virtual image is visible by both eyes of a human viewer, i.e., that light rays from any given point of the virtual image enters both eyes simultaneously. The viewer's eyes may by located anywhere within a certain volume to see the virtual image. The depth of the virtual image is the depth each eye accommodate, or focuses to. The volume is called the headbox, and it spans a lateral dimension. The lateral dimension may be, for example, at least 8 cm, at least 10 cm, at least 15 cm, at least 20 cm, or at least 30 cm. The distance between the display system and the nearest viewing position in the headbox may be, for example, 20 cm, 30 cm, 40 cm, 50 cm, 60 cm, 70 cm, 80 cm, 90 cm, or 100 cm. In some embodiments, the nearest viewing position is greater than 100 cm. This distance is in part limited by the viewing direction required to see the virtual image.

Further, the virtual image is an image whereby the imaging-forming light rays corresponding to a given point of the image do not physically intersect. Rather, they diverge or are collimated. When the image-forming light rays are geometrically projected backward, their projections do intersect. This intersection point is the location of the virtual image. (In contrast, the image that is formed by physically intersecting light rays is a real image that may be projected onto a screen or other physical surface without any other focusing elements.) In some embodiments, a virtual image is viewed by a viewer.

In some embodiments, the first element 73 or the second element 74 of FIG. 17 is polarization-dependent. In some embodiments, they are semi-reflectors or partial reflectors. For example, the first element 73 may be a polarization-changing semi-reflector, which is an element that transmits at least a portion of the light incident on it and further converts the incident light's polarization from one state into another. In some embodiments, a polarization-changing semi-reflector comprises a first wave plate, a beam splitter or other semi-reflector, and a second wave plate. In some embodiments, the wave plates are quarter-wave plates. If linear polarized light is incident on this polarization-changing semi-reflector, the light that is transmitted will be linearly polarized, but the direction of the polarization will be rotated by 90 degrees, i.e., incident x-(y-)polarized light is converted into y-(x-)polarized light. Further, linearly polarized light that is reflected by this element is also rotated by 90 degrees.

In some embodiments, either element 73 or 74 is a polarization-changing reflector, which is an element that reflects the light incident on it and further converts the incident light's polarization from one state into another. In some embodiments, a polarization-changing reflector comprises a mirror and wave plate. The wave plate is a quarter-wave plate in some embodiments. Incident linearly polarized light will be reflected and the polarization orientation will be rotated 90 degrees. The states of polarization under consideration may be linear polarization, circular polarization, or elliptical polarization. In some embodiments, the degree of polarization is included in the state of polarization.

In some embodiments, the first element 73 or second element 74 is a reflective polarizer, which transmits light of a first polarization state and reflects light of a second polarization state that is orthogonal to the first polarization state. An example of a reflective polarizer is a wire-grid polarizer. In some embodiments, the reflective polarizer is a polarization-dependent beam splitter (PBS).

In some embodiments, the optical properties of the first element 73 or second element 74 are controlled by an electronic signal. For example, the above mentioned waveplate in the polarization-changing (semi-)reflector may be a liquid crystal (LC), such as a nematic LC or a cholesteric LC.

When a first voltage is applied to it, it may transmit light without changing its polarization (thus preserving the polarization), When a second voltage is applied to it, it may change the polarization from a first state to a second such as a conversion from horizontally polarized light to vertically polarized light. The voltage values may be arbitrarily engineered and include 0 V. For example, if the first element 73 comprises a first wave plate, a beam splitter, and a second wave plate; and one of the wave plates is a liquid crystal, then the applied voltage impacts how the polarization of transmitted and reflected light is changed. At one voltage, transmitted polarization may rotate 90 degrees. At a second voltage, it may rotate 0 degrees. At a third voltage, incident linear polarization may be converted into circular polarization. Thus, the type of wave plate and the configuration of an LC can impact the transmitted polarization. Consequently, the transmitted light will interact differently with the second element 74.

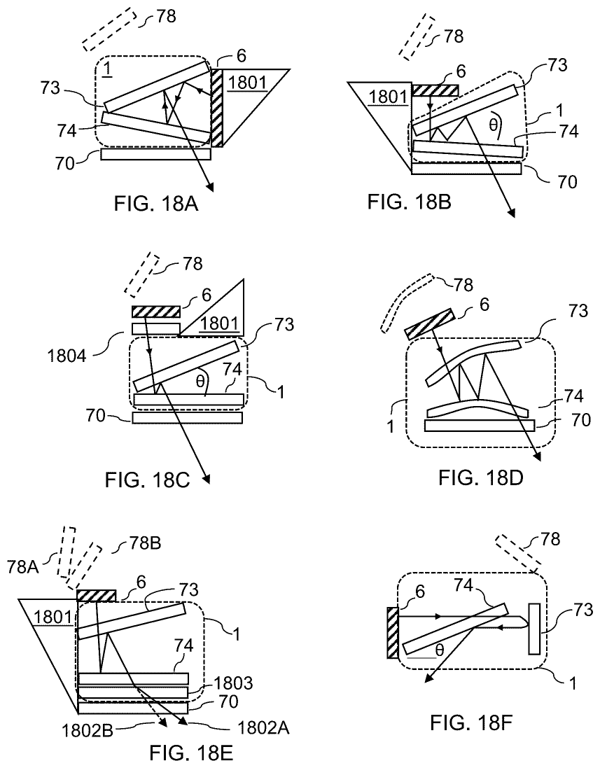

FIGS. 18A through 18F depict a set of embodiments related to FIG. 17. In FIG. 18A, light having a first polarization state is emitted from a display 6 and enters a field-evolving cavity 1. In all embodiments shown in FIGS. 18A-18F, the field-evolving cavity 1 includes the first element 73 and second element 74, and it may include additional optical elements as well as a structure to mechanically support the elements. Inside the cavity, the light first is reflected from a first element 73, which is a polarization-changing reflector. The light is then reflected by a second element 74, with a reflective polarizer, and then reflected by the first element 73 again. The polarization state is such that the light is transmitted by the second element 74 when the light is incident on it a second time. The transmitted light passes through an aperture optic 70 and exits the cavity to the outside world. In some embodiments, the aperture optic 70 comprises an absorptive polarizer and an antireflection layer. In some embodiments, the aperture optic is a transparent material, such as a glass layer.

When the light is viewed by a viewer, it forms a virtual image 78 that is farther away from the viewer than is the field-evolving cavity itself. Further, the angle of the first element 73 relative to the second element 74 is less than 45 degrees, so that the orientation of the virtual image is shallower than that of the display itself. Further, because the angle is less than 45 degrees, the field-evolving cavity can be thinner.

The display system and any electronically addressable or electrically active of the cavity are controlled by a circuit block 1801. In some embodiments, the circuit block is coupled to an electronic system of the vehicle. In some embodiments, the circuit block is an integrated part of the display system and serves to provide content of the virtual imagery.

FIG. 18B depicts an embodiment in which the display 6 is substantially parallel with the aperture optic 70. The display sends light through a first element 73, which may be a polarization-changing semi-reflector. The polarization state is rotated 90 degrees, reflected by the second element 74, which may be a reflective polarizer or PBS, then reflected by the first element 73, which rotates the polarization another 90 degrees such that is transmitted by the second element 74, and passes through the aperture optic 70. A virtual image 78 is formed, and it is located at a depth that is farther than the field-evolving cavity 1 and also farther than the display 6 itself. A circuit block 1801 controls the display content. In some embodiments, the polarization-changing semi-reflector includes a first wave plate, a beam splitter, and a second wave plate. In some embodiments, the aperture optic 70 includes an absorptive polarizer and/or an antireflection element. These are just examples, and any suitable configuration of first element 73, second element 74, and aperture optic 70 may be used. In some embodiments, a directional film is introduced in the beam path. The angle between the first and second elements is θ, which is less than 45 degrees.

In an FEC, the light is reflected back and forth, or is circulated, between the elements of the cavity. Each of these propagations is a pass. For example, an FEC may have a first element and a second element. The first instance of light propagating from the first element to the second element is called a forward pass. When the light, or a selected part of light, is reflected from the second element back to the first element, that propagation is called a backward pass, as the light is propagating backward toward the light source. In this cavity, a round trip occurs once the light completes one cycle (forward and backward pass) and returns to the first element. In some embodiments, a round trip occurs when light substantially reverses direction and is incident on an element more than once. The term “round trips” denotes the number of times that light circulates or bounces back and forth between the two elements of a cavity or the number of times light interacts with a single element.

In some embodiments, the light travels one round trip within the FEC 1. In some embodiments, the number of round trips may be 2, 3, 4, or 5. The number of round trips substantially determines the monocular depth perceived be a viewer. In some embodiments, a monocular depth is larger than the distance between the viewer and the light source. For example, the ratio between the monocular depth and the distance may be 1.1, 1.5, 2, 2.5, 3, 4.5, or 5. In some embodiments, the ratio may lie within a range, such as 1.1-2, 1.5-3, or 2-5. In some embodiments, a monocular depth is dynamically adjustable by modifying a property of the virtual display system.

In embodiments such as that in FIG. 18A, there is one round trip. In the embodiment of FIG. 18B, there are two round trips. The mechanism for introducing more round trips includes modifying the properties of the first and second element. For example, by using a different type of wave plate or an LC in the first element, the reflected polarization (after the first round trip) can be configured differently, such that most of the light is reflected a second time by the second element. Further, the second element, may also include a polarization-changing element, such as a wave plate or LC, to modify the polarization of the light that it reflects. Further, both the polarization changes and the reflectivity and transmittivity of these elements may be a function of angle. For example, either element may include a multilayer film. In such embodiments, because the angle of the light rays change with each round trip, the light may be substantially transmitted by the second element after a desired angle is reached.

FIG. 18C shows an embodiment similar to that in FIG. 18B. Light from a display 6 passes through a pre-cavity element 1804, which includes a directional film in some embodiments. A directional film selectively transmits light rays that are oriented at angles within a specified angular range and blocks light rays directed outside that range. For example, the directional film may transmit light rays that are incident within a range from zero to 10 degrees, zero to 20 degrees, zero to 30 degrees, zero to 40 degrees, zero to 50 degrees, or zero to 60 degrees. The directional film does not provide optical (focusing) power. In some embodiments, the directional film transmits an angular range that does not start at zero degrees.

The light then passes through the first element 73 which is a polarization-changing semi-reflector. The light is reflected by the second element 74, which is a reflective polarizer and makes a round trip within the field-evolving cavity 1. The light then exits the system through the aperture optic 70. In some embodiments, the aperture optic 70 is an absorptive polarizer or an antireflection layer. In some embodiments, the aperture optic 70 is a transparent element, such as a layer of glass or similar material. A virtual image 78 is formed, the virtual image orientation tilted with respect to the display orientation. A circuit block 1801 controls the display content and any active components, such as an LC or electrooptic material that may be included in the first element 73 or second element 74. The angle between the first and second elements is θ, which is less than 45 degrees.

FIG. 18D shows an embodiment in which elements of the field-evolving cavity 1 are curved. Light from a display 1 enters the cavity through a first element 73 which is a curved polarization-changing semi-reflector. The polarization exiting this element is such that it is reflected by a curved second element 74, which may be a reflective polarizer. The light is then reflected by the first element and rotated in polarization, and it then passes through the second element and through the aperture optic 70 forming a virtual image 78. The curvature of the elements creates optical power and allows the image to be magnified or minified and for its depth to be adjusted. In some embodiments, the curved elements are coatings on curved substrates. In some embodiments, the curved elements are freeform elements, and the curvature or shape of the elements is defined by a function.

In any of these embodiments, the angle between the first element 73 and the second element 74 may be less than 45 degrees. For example, it may be by 1, 5, 10, 15, 20, 25, 30, 35, 40, or 44 degrees.

FIG. 18E shows an embodiment, in which the field-evolving cavity includes an electrooptic (EO) material 1803 whose refractive index changes in accordance with an applied voltage. For example, when a first voltage is applied by a circuit block 1801, the EO material 1803 has a first value of refractive index; and when a second voltage is applied it takes on a second value of the refractive index. In some embodiments, the refractive index is not uniform, but varies linearly across the element, such that when the applied voltage changes, the variation changes, making the EO material 1803 an electrically controllable prism. For example, if the refractive index in the horizontal direction is given by n(x)=n₀+A(V)x, where x is the position, and A(V) is a function of applied voltage, the light will be deflected in a direction dependent on the value of A(V). Therefore, light that is emitted by a display 6 passes through a first element 73, is reflected by a second element 74, is reflected by the first element, and is transmitted through the EO material 1803. It is deflected by it and transmitted through an aperture optic 70. The deflection may be in a first direction 1802A producing a first virtual image 78A, or in a second direction 1802B to produce a second virtual image 78B depending upon the state of EO material 1803. In some embodiments, the display content is precompensated to account for any aberrations introduced by the EO material.

That is, the display content may be distorted such that the combination of the distortion and any aberration results in a clear virtual image. In some embodiments, the function n(x) is not linear, but, rather, a function that varies so as to minimize aberrations. For example, the function may be a polynomial of order higher than 1, a logarithmic function, an exponential function, and the like.

FIG. 18F shows an embodiment in which light from a display 6 enters the field-evolving cavity 1 from the left. It passes through the second element 74 and is reflected by the first element 73. Upon reflection in some embodiments, the light's polarization is modified, so that it is reflected by the second element and exits the system forming a shallow virtual image 78. The angle is less than 45 degrees.

In any of the embodiments above, a directional film may overlay the display panel to tilt the emitted light in a preferred direction before entering the field-evolving cavity.

An advantage of these embodiments is that the virtual image is tilted at an angle that depends on the angle between the first element 73 and the second element 74. If the angle between them is called θ, the tilt in the light accumulates by approximately 2θ after each round trip inside the FEC. So if θ lies in a range between 1 and 30 degrees, the virtual image will be tiled relative to the display by a range between 2 and 60 degrees after one round trip. If θ lies in a range between 1 and 10 degrees, the virtual image will be tiled relative to the display by a range between 3 and 30 degrees after two round trips.

Another advantage is the thinness of the display system. If the lateral with is W~30 cm, and the angle θ is 30 degrees, the thickness of the FEC is approximately W tan θ, or 17 cm. The shallower the angle is, the thinner the display system is. The thickness of the display may be 5 cm, 10 cm, 20 cm, or 30 cm. Further, the virtual image size may be approximately the same as the display. In some embodiments, the virtual image is larger by, for example, a factor of 1.2, 1.5, 2, 2.5, 3, 3.5, or 4.

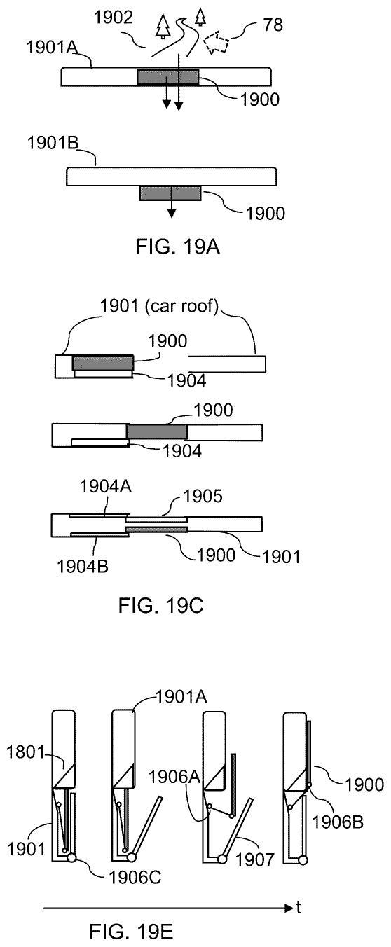

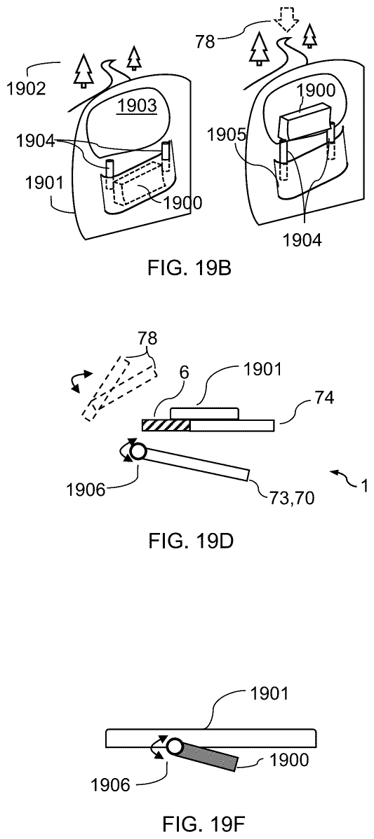

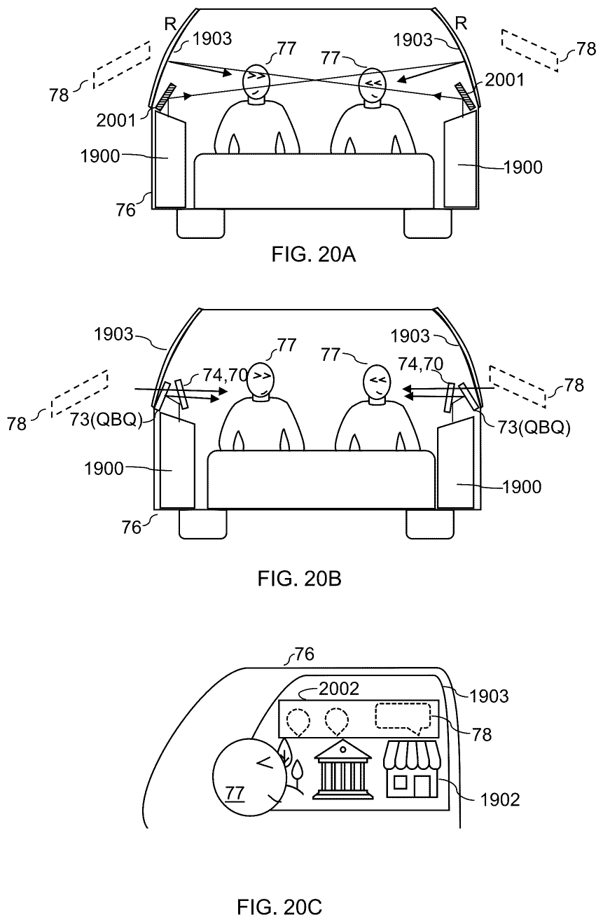

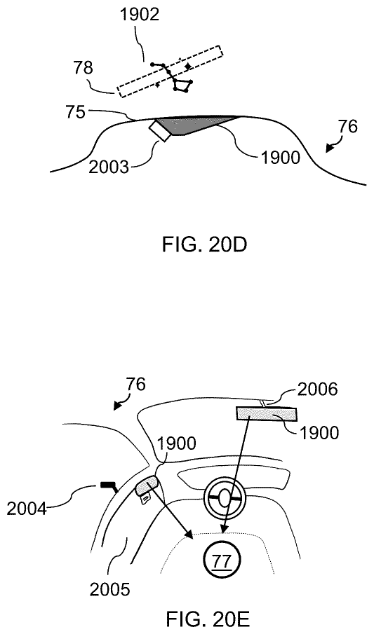

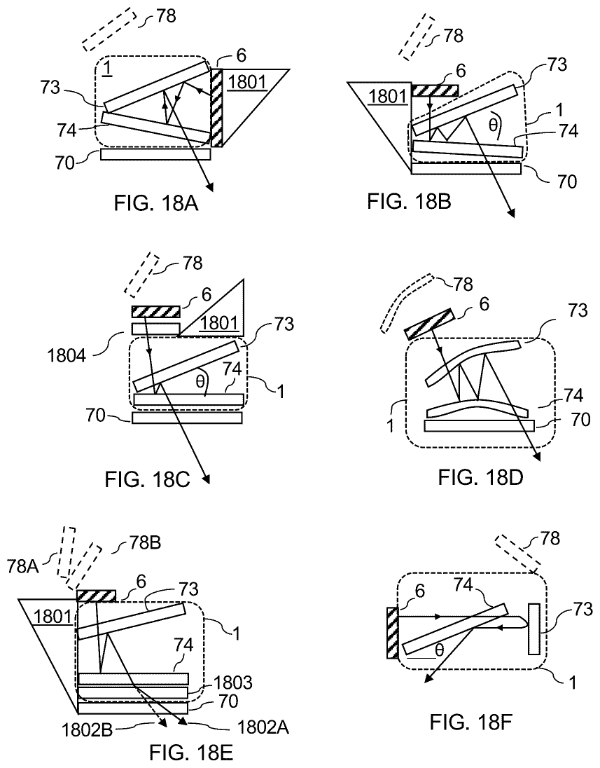

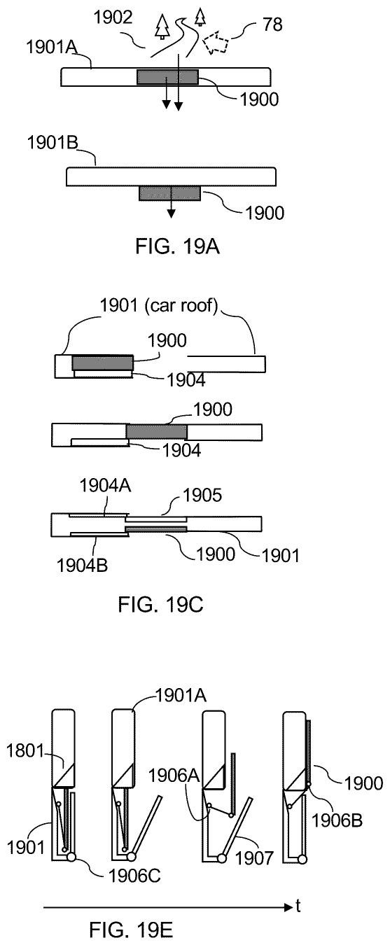

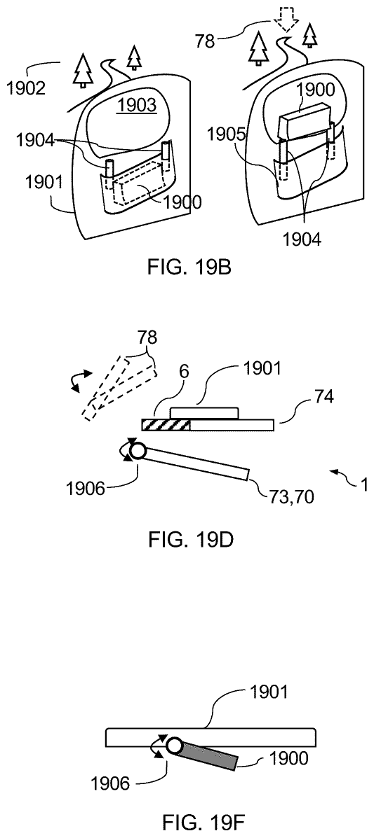

FIGS. 19A through 19F show embodiments in which the display system described above is integrated into a vehicle. FIG. 19A is an embodiment in which the display system 1900 is integrated to a vehicle. The elements of display system include the display itself, the field-evolving cavity, and any pre-or post-cavity elements. In some embodiments, the display system includes an aperture optic as an element. The display system produces a virtual image. In some embodiments, the display system 1900 is integrated into a vehicle part 1901A. In some embodiments, the display system 1900 is overlaid on a window and lets light from an external scene 1902 pass through it such that the virtual image 78 overlaps with the scene and creates augmented reality (AR) environment. In some embodiments, the display system 1900 is connected to a surface of a vehicle part 1901B. Vehicle parts 1901A and 1901B may be, for example and not limitation, a roof, side panel, door, seat, seatback, window, or mirror. Because the display system is thin (because of the acute angle between the first and second element), it is substantially flush with a surface of the vehicle, and any recessed cavities will take up little space to house it when not in use. A bulkier display will jut out more and will usually require mechanisms to collapse it when not in use or require more space within the vehicle.

There are limitations to the placement of the present invention, dictated by its lateral size, distance to a viewer, and viewing direction to see the obliquely oriented virtual image. Specifically, an imaginary line that extends from the viewer's eyes to the virtual image must pass through the aperture optic (or the geometric surface where an aperture optic may be placed). This would not be the case, for example, for display systems with relatively small lateral dimensions that are positioned closer to a viewer.

FIG. 19B shows an embodiment in which a display system 1900 is set in a first position in a pocket 1905 or recessed region of a vehicle part 1901. The display system is moved into place, for example, over a window 1903, by a mechanical track 1904. Through the window, an external scene 1902 is visible. With the display system in place, a see-through AR effect is generated, and a virtual image 78 is formed over the scene. In some embodiments, the display system produces augmented reality using see-through video: a camera attached to an external part of the vehicle captures the external scene and displays the captured information on the display of the display system itself.

FIG. 19C shows an embodiment in which the display system 1900 is integrated into a vehicle part 1901 that is a car roof, and the display system is at least partially see-through. A mechanical track 1904 slides the display system into place from a recessed cavity within the roof. In some embodiments, the display system acts as a vehicle sun roof or window. In some embodiments, there is a separate sunroof 1905, and the display system and sunroof are independently controlled by a first mechanical track 1904A and a second mechanical track 1904B.

FIG. 19D shows an embodiment in which a portion of the display system is mechanically adjustable relative to the other components to modify the position and orientation of the virtual image. A display 6 is fixed to a vehicle part 1901 and light from the display is reflected by a first element 73, then reflected by a second element 74, and then transmitted by the first element 73 and through an aperture optics 70. The aperture optic and first element are rotatable by a hinge 1906 which has the effect of shifting and rotating the virtual image 78. That is, the rotation changes the viewing experience during use of the display system. In some embodiments, the hinge is motorized. In some embodiments, the hinge is adjusted directly by a user. The hinge is an example of a moveable joint, which includes hinges, ball joints, or tracks along with the display system, or an element of it, may move relative to the vehicle. A hinge includes at least a first portion and a second portion that move relative to one another. For example, the first portion may be secured to a vehicle part and the second portion to part or all of the display system.

FIG. 19E shows an embodiment in which the display system 1900 may reside in a recess portion within a vehicle part 1901. A pair of hinges 1906A, 1906B move the display system in place, in front of a second vehicle part 1901A. A third hinge 1906C moves a panel 1907 to allow for the motion of the display system. The vehicle parts 1901A and 1901 may be parts of a seat within the vehicle. A circuit block 1801 may be used to control the motion of the hinges and display system as time t evolves.

FIG. 19F shows an embodiment that combines aspects of FIGS. 19A and 19D. Here, the entire display system 1901 is connected to a vehicle part 1901 via a hinge 1906, which may be articulated to adjust the entire display system. The position of the resulting virtual image changes, but its position relative to the display system is fixed. In some embodiments, the hinge is instead an articulated arm or ball joint that may rotate the display system in multiple directions, i.e., that may rotate it about different axes of rotation.

In any of the embodiments above, the mechanical integration-the levers, arms, hinges, and tracks, may be motorized and controllable through buttons integrated into the vehicle, or they may be manually adjustable based on a viewer's actions.

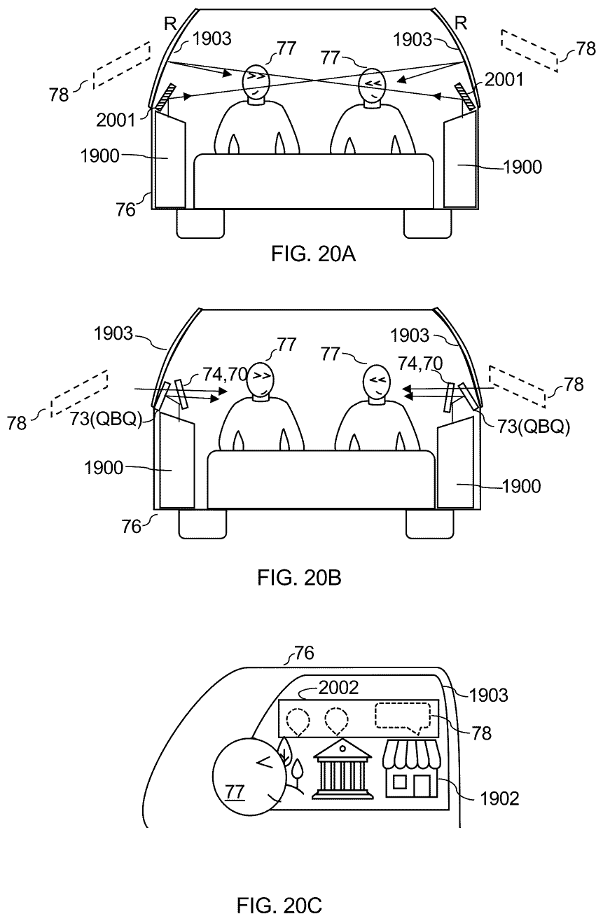

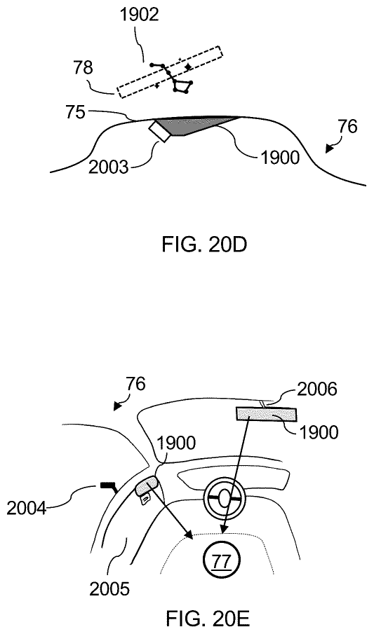

FIGS. 20A through 20E are example embodiments of applications of the display system in a vehicle. In FIG. 20A a vehicle 76 houses two display systems 1900. These may be the display systems described above. The light exits the display systems 1900 and is reflected across the vehicle by a mirror 2001. The reflected light is subsequently reflected again by the side windows 1903 and enter the eyes of the viewers 77. In some embodiments, the windows are curved with a radius of curvature R, such that they provide optical power and assist in collimating the light, forming virtual images 78 that have very far depths outside the vehicle.

A similar embodiment is shown in FIG. 20B. The vehicle 76 has integrated into its sides display systems 1900. In this embodiment, the display system may have further external components to complete the imager formation. A second element 74 reflects light to a first element 73, which is a polarization-changing semi-reflector. The light is rotated by 90 degrees and is transmitted by the second reflector, which may be a reflective polarizer. The light then is viewed by the viewers 77 as virtual images 78. Because the first elements are semi-reflective, they allow light from the external environment to pass through, such that the overlaid virtual images create an AR environment.

An example of such an environment is shown in FIG. 20C. The viewer 77 looks through the side window 1903 of the vehicle 76 and sees the external environmental scene 1902. A portion 2002 of the scene overlaps with the virtual image 78, which may include annotations. In some embodiments, the annotations are generated at least in part by a GPS module or navigation system. FIG. 20D shows an embodiment in which the display system 1900 is fixed to the roof 75 of a vehicle 76 to form a virtual image 78 above the vehicle. In some embodiments, the display system is partially transparent and allows external light to pass through it so that the external scene 1902 is simultaneously visible. In some embodiments a GPS module 2003 may be electrically coupled to the display system to produce content that depends on the vehicles coordinates or orientation relative to the environment. In some embodiments a simultaneous localization and mapping (SLAM) module is coupled to the display system. A SLAM module uses a computational algorithm to map out the vehicle's environment while simultaneously tracking the vehicle's position within the environment. Such algorithms include extended Kalman filter or the particle filter. Such a module is useful in particular for autonomous vehicles.

FIG. 20E shows an embodiment in which display systems 1900 are integrated to perform the function of conventional mirrors of the vehicle, similar to that of FIG. 16. In this embodiment content from the external environment is captured by a camera 2004 fixed to an external part of the scene. In some vehicles, the camera is approximately at the location of a conventional side mirror, and a side mirror is absent. The camera may capture information about the environment to the side of the vehicle and display it on the display system 1900 fixed to the interior of the vehicle 76, e.g., to an interior door 2005. In some embodiments, a camera captures information about the rear of the vehicle and displays it on the display system 1900 fixed to vehicle by an arm 2006, e.g., in place of a conventional rearview mirror. The advantage of this scenario, as compared to conventional “digital mirrors,” which are simply display panels that replace the mirrors, is that the depths associated with objects in the external environment may be preserved by the depth of the display systems'virtual images.

Although the invention has been explained in relation to its preferred embodiment, it is to be understood that many other possible modifications and variations can be made without departing from the spirit and scope of the invention as hereinafter claimed.

In this document, various aspects may be described algorithmically. While exemplary algorithms may be provided, the desired functionality may be implemented in any suitable way. One of skill in the art may implement such functionality or algorithms, for example, in hardware, in software, or in a combination of hardware and software. A module (e.g., “GPS module”, “SLAM module”) may comprise the hardware and/or software, to implement the functionality or algorithm disclosed. For example, in some embodiments an algorithm may be implemented through a module having one or more processors executing computer code stored on one or more non-transitory computer-readable storage media. In some embodiments, a functionality is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations).

In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. In some embodiments, an algorithm may be recorded as a software module. The capability may be implemented, for example, by reading the software module from a storage medium and executing it with one or more processors, or by reading the software module from a storage medium and using the information to configure hardware.

In this document, the terms “machine readable medium,” “computer readable medium,” and similar terms are used to refer to non-transitory mediums, volatile or non-volatile, that store data and/or instructions that cause a machine to operate in a specific fashion. Common forms of machine-readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skills in the art after reading this document, the illustrated embodiments and their various alternatives can be implemented without confinement to the illustrated examples. For example, block diagrams and their accompanying description should not be constructed as mandating a particular architecture or configuration.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in several ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine, but deployed across a number of computational resources.

As used herein, the term “or” may be constructed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be constructed as open ended as opposed to limiting. Adjectives such as “conventional,” “traditional,” “normal,” “standard,” “known,” and terms of similar meaning should not be constructed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A display system comprising:
a display panel to emit light; and
a field-evolving cavity to direct the light from the display panel along a path to produce a virtual image oriented at an oblique angle relative to the display panel, the field-evolving cavity having
a polarization-changing reflector positioned along the path to convert the light from a first polarization to a second polarization;
a polarization-dependent reflector disposed along the path after the polarization-changing reflector, at an angle less than 45 degrees relative to the polarization changing reflector, to reflect light of the second polarization and transmit light of the first polarization; and
an aperture optic to transmit the light away from the field-evolving cavity.

2. The display system of claim 1, further comprising a vehicle having mounted therein the display panel and the field-evolving cavity.

3. The display system of claim 2, wherein a depth of the virtual image is outside the vehicle.

4. The display system of claims 2, further comprising a camera to capture information about an external environment, wherein the virtual image is based on the information.

5. The display system of claim 1, wherein the polarization-changing reflector comprises a wave plate and a reflector.

6. (canceled)

7. The display system of claim 1, wherein the display panel and the field-evolving cavity are mounted to a roof of a vehicle.

8. The display system of claim 1, wherein the display panel and field-evolving cavity are mounted to a vehicle part selected from the group consisting of a roof, door, seat, floor, and side panel.

9. (canceled)

10. The display system of claim 1, wherein a thickness of the display system is smaller than a lateral dimension of the display system.

11-12. (canceled)

13. A display system comprising:
a display panel to emit light; and
a field-evolving cavity to direct the light from the display panel along a path to produce a virtual image oriented at an oblique angle relative to the display panel, the field-evolving cavity having
a polarization-changing semi-reflector positioned to transmit and convert the light from a first polarization to a second polarization; and
a polarization-dependent reflector disposed along the path after the polarization changing semi-reflector, at an angle less than 45 degrees relative the polarization changing semi-reflector; and
an aperture optic to transmit the light away from the field-evolving cavity.

14. The display system of claim 13, further comprising a vehicle having mounted therein the display panel and the field-evolving cavity.

15. The display system of claim 14, wherein a depth of the virtual image is outside the vehicle.

16. (canceled)

17. The display system of claim 14, further comprising a camera to capture information about an external environment, wherein the display panel and the field-evolving cavity are mounted within the vehicle, and the virtual image is based on the information.

18. The display system of claim 14, further comprising a movable joint having a first portion and second portion that move relative to another with movement of the movable joint, wherein the first portion is mounted to the vehicle and at least one of the field-evolving cavity, the display panel, and the aperture optic are mounted to the second portion.

19. The display system of claim 13, wherein the polarization-changing semi-reflector comprises a first wave plate, a beam splitter, and a second wave plate.

20-21. (canceled)

22. The display system of claim 13, wherein the display panel and field-evolving cavity are mounted to a roof of a vehicle.

23. The display system of claim 13, wherein the display panel and field-evolving cavity are mounted to a vehicle part selected from the group consisting of a roof, door, seat, floor, side panel and window.

24. (canceled)

25. The display system of claim 13, wherein the display is oriented at an oblique angle relative to the polarization-changing reflector.

26. The display system of claim 13, wherein a thickness of the display system is smaller than a lateral dimension of the display system.

27-31. (canceled)

32. A vehicular display system comprising:
a display panel to emit light;
a field-evolving cavity to direct the light from the display panel and produce a virtual image, the field-evolving cavity having
a plurality of polarization-dependent semi-reflectors; and
an aperture optic; and
a vehicle having mounted thereon the display panel and the field-evolving cavity, wherein a depth of the virtual image lies outside of the vehicle.

33. The vehicular display system of claim 32, wherein the virtual image is formed after reflection by a surface of the vehicle, and the virtual image lies beyond a lateral side of the vehicle.

34. (canceled)

35. The vehicular display system of claims 32, wherein a global positioning system (GPS) or simultaneous localization and mapping (SLAM) module is used to modify content of the virtual image.

36. The vehicular display system of claim 32, wherein the field-evolving cavity further comprises a polarization-dependent reflector and a polarization changing semi-reflector.

37. (canceled)

38. The vehicular display system of claim 32, wherein the light travels a plurality of round trips within the field-evolving cavity.

39. The display system of claim 1, wherein the oblique angle between the virtual image and the display panel is a first oblique angle, and the display panel is oriented at a second oblique angle relative to the polarization changing reflector.

40. The display system of claim 10, wherein the oblique angle is a first oblique angle, and the polarization-changing semi-reflector and the display panel form a second oblique angle.
